(19) United States
(12) Patent Application Publication
(10) Pub. No.: US 2026/0254565 A1
(43) Pub. Date: Aug. 27, 2026

(54) TECHNIQUES FOR HANDLING HYBRID AUTOMATIC REPEAT REQUEST-ACKNOWLEDGMENT (HARQ-ACK) CODEBOOK SIZE MISMATCH

(71) Applicant: QUALCOMM Incorporated, San Diego, CA (US)

(72) Inventors: Morteza SOLTANI, San Diego, CA (US); Mostafa KHOSHNEVISAN, San Diego, CA (US); Jing SUN, San Diego, CA (US)

(21) Appl. No.: 19/060,380

(22) Filed: Feb. 21, 2025

(51) Int. Cl. H04L 1/1812; H04L 27/20; H04L 27/26; H04W 72/21

(52) U.S. Cl. CPC H04L 1/1812; H04L 27/2082; H04L 27/2607; H04W 72/21

(57) ABSTRACT

Methods, systems, and devices for wireless communications are described. A user equipment (UE) may receive one or more downlink messages and generate one or two bits of hybrid automatic repeat request-acknowledgment (HARQ-ACK) information. The UE may generate an uplink control information (UCI) message by either transmitting a single HARQ bit (to which a receiving network entity adds an implicit zero-padding bit), or by appending one or more explicit zero-padding bits to the HARQ information to generate a zero-padded HARQ bit sequence. In some aspects, the payload size of the zero-padded HARQ bit sequence may include two or three bits. The UE may then transmit the UCI message in accordance with a sequence cyclic shift value (or other encoding scheme) corresponding to the payload size of the zero-padded HARQ bit sequence. The receiving network entity may then receive and interpret the implicitly zero-padded HARQ information or the explicitly zero-padded HARQ information.

### FIELD OF TECHNOLOGY

The following relates to wireless communications, including techniques for handling hybrid automatic repeat request-acknowledgment (HARQ-ACK) codebook size mismatch.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, one or more downlink messages, generating hybrid automatic repeat request (HARQ) information corresponding to respective downlink messages of the one or more downlink messages, the HARQ information including one bit or two bits, generating an uplink control information (UCI) message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits, and transmitting the UCI message in accordance with a sequence cyclic shift value corresponding to the payload size of the zero-padded HARQ bit sequence.

A UE for wireless communications is described. The UE may include one or more memories storing processor executable code, and one or more processors coupled with the one or more memories. The one or more processors may individually or collectively be operable to execute the code to cause the UE to receive, from a network entity, one or more downlink messages, generate HARQ information corresponding to respective downlink messages of the one or more downlink messages, the HARQ information including one bit or two bits, generate an UCI message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits, and transmit the UCI message in accordance with a sequence cyclic shift value corresponding to the payload size of the zero-padded HARQ bit sequence.

Another UE for wireless communications is described. The UE may include means for receiving, from a network entity, one or more downlink messages, means for generating HARQ information corresponding to respective downlink messages of the one or more downlink messages, the HARQ information including one bit or two bits, means for generating an UCI message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits, and means for transmitting the UCI message in accordance with a sequence cyclic shift value corresponding to the payload size of the zero-padded HARQ bit sequence.

A non-transitory computer-readable medium storing code for wireless communications is described. The code may include instructions executable by one or more processors to receive, from a network entity, one or more downlink messages, generate HARQ information corresponding to respective downlink messages of the one or more downlink messages, the HARQ information including one bit or two bits, generate an UCI message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits, and transmit the UCI message in accordance with a sequence cyclic shift value corresponding to the payload size of the zero-padded HARQ bit sequence.

In some examples of the method, UEs, and non-transitory computer-readable medium described herein, transmitting the UCI message may include operations, features, means, or instructions for transmitting the UCI message in accordance with a first uplink control channel format or a second uplink control channel format that does not include a scheduling request, where the sequence cyclic shift value may be based on the one bit of the HARQ information and one zero padding bit included in the zero-padded HARQ bit sequence.

In some examples of the method, UEs, and non-transitory computer-readable medium described herein, for the first uplink control channel format, the sequence cyclic shift value includes a sequence cyclic shift value of 0 associated with a bit sequence of {0,0} for the zero-padded HARQ bit sequence, or a sequence cyclic shift value of 9 associated with a bit sequence of {1,0} for the zero-padded HARQ bit sequence.

In some examples of the method, UEs, and non-transitory computer-readable medium described herein, for the second uplink control channel format, the sequence cyclic shift value includes a sequence cyclic shift associated with a quadrature phase shift keying (QPSK) mapping associated with a bit sequence of {0,0} for the zero-padded HARQ bit sequence, or a sequence cyclic shift associated with a QPSK mapping associated with a bit sequence of {1,0} for the zero-padded HARQ bit sequence.

In some examples of the method, UEs, and non-transitory computer-readable medium described herein, the first uplink control channel format includes a physical uplink control channel (PUCCH) format 0 and the second uplink control channel format includes a PUCCH format 1.

In some examples of the method, UEs, and non-transitory computer-readable medium described herein, transmitting the UCI message may include operations, features, means, or instructions for transmitting the UCI message in accordance with a first uplink control channel format or a second uplink control channel format that includes either a positive scheduling request or a negative scheduling request, where the sequence cyclic shift value may be based on the one bit of the HARQ information and one zero padding bit included in the zero-padded HARQ bit sequence.

In some examples of the method, UEs, and non-transitory computer-readable medium described herein, for the first uplink control channel format that includes the negative scheduling request, the sequence cyclic shift value includes a sequence cyclic shift value of 0 associated with a bit sequence of {0,0} for the zero-padded HARQ bit sequence, or a sequence cyclic shift value of 9 associated with a bit sequence of {1,0} for the zero-padded HARQ bit sequence.

In some examples of the method, UEs, and non-transitory computer-readable medium described herein, for the first uplink control channel format that includes the positive scheduling request, the sequence cyclic shift value includes a sequence cyclic shift value of 1 associated with a bit sequence of {0,0} for the zero-padded HARQ bit sequence, or a sequence cyclic shift value of 10 associated with a bit sequence of {1,0} the zero-padded HARQ bit sequence.

In some examples of the method, UEs, and non-transitory computer-readable medium described herein, the first uplink control channel format includes a PUCCH format 0 and the second uplink control channel format includes a PUCCH format 1.

In some examples of the method, UEs, and non-transitory computer-readable medium described herein, transmitting the UCI message may include operations, features, means, or instructions for multiplexing the UCI message via an uplink shared channel, where the UCI message may be encoded in accordance with a Reed-Muller code.

In some examples of the method, UEs, and non-transitory computer-readable medium described herein, transmitting the UCI message may include operations, features, means, or instructions for transmitting the UCI message in accordance with a PUCCH format 2, a PUCCH format 3, or a PUCCH format 4, where the UCI message may be encoded in accordance with a Reed-Muller code.

Some examples of the method, UEs, and non-transitory computer-readable medium described herein may further include operations, features, means, or instructions for receiving, from the network entity, control signaling indicating a transmission scheme for the UCI message, where the transmission scheme may be based on a zero-padding configuration, an uplink channel and UCI payload multiplexing configuration, an uplink control channel format indication, or any combination thereof.

In some examples of the method, UEs, and non-transitory computer-readable medium described herein, the control signaling includes radio resource control signaling, a medium access control-control element (MAC-CE), a downlink control information (DCI) message, or any combination thereof.

A method for wireless communications by a network entity is described. The method may include outputting, to a UE, one or more downlink messages, obtaining, from the UE, an UCI message including HARQ information corresponding to respective downlink messages of the one or more downlink messages, the HARQ information including one bit or two bits, and decoding the HARQ information of the UCI message in accordance with a sequence cyclic shift value corresponding to a payload size of a zero-padded HARQ bit sequence including two bits or three bits, where the zero-padded HARQ bit sequence includes the HARQ information received via the UCI message and one or more zero-padding bits implied by the network entity.

A network entity for wireless communications is described. The network entity may include one or more memories storing processor executable code, and one or more processors coupled with the one or more memories. The one or more processors may individually or collectively be operable to execute the code to cause the network entity to output, to a UE, one or more downlink messages, obtain, from the UE, an UCI message including HARQ information corresponding to respective downlink messages of the one or more downlink messages, the HARQ information including one bit or two bits, and decode the HARQ information of the UCI message in accordance with a sequence cyclic shift value corresponding to a payload size of a zero-padded HARQ bit sequence including two bits or three bits, where the zero-padded HARQ bit sequence includes the HARQ information received via the UCI message and one or more zero-padding bits implied by the network entity.

Another network entity for wireless communications is described. The network entity may include means for outputting, to a UE, one or more downlink messages, means for obtaining, from the UE, an UCI message including HARQ information corresponding to respective downlink messages of the one or more downlink messages, the HARQ information including one bit or two bits, and means for decoding the HARQ information of the UCI message in accordance with a sequence cyclic shift value corresponding to a payload size of a zero-padded HARQ bit sequence including two bits or three bits, where the zero-padded HARQ bit sequence includes the HARQ information received via the UCI message and one or more zero-padding bits implied by the network entity.

A non-transitory computer-readable medium storing code for wireless communications is described. The code may include instructions executable by one or more processors to output, to a UE, one or more downlink messages, obtain, from the UE, an UCI message including HARQ information corresponding to respective downlink messages of the one or more downlink messages, the HARQ information including one bit or two bits, and decode the HARQ information of the UCI message in accordance with a sequence cyclic shift value corresponding to a payload size of a zero-padded HARQ bit sequence including two bits or three bits, where the zero-padded HARQ bit sequence includes the HARQ information received via the UCI message and one or more zero-padding bits implied by the network entity.

In some examples of the method, network entities, and non-transitory computer-readable medium described herein, decoding the UCI message may include operations, features, means, or instructions for decoding the UCI message in accordance with a first uplink control channel format or a second uplink control channel format that does not include a scheduling request, where the sequence cyclic shift value may be based on the zero-padded HARQ bit sequence including the one bit of the HARQ information and one zero-padding bit implied by the network entity.

In some examples of the method, network entities, and non-transitory computer-readable medium described herein, for the first uplink control channel format, the sequence cyclic shift value includes a sequence cyclic shift value of 0 associated with a bit sequence of {0,0} for the zero-padded HARQ bit sequence, or a sequence cyclic shift value of 6 associated with a bit sequence of {1,0} for the zero-padded HARQ bit sequence.

In some examples of the method, network entities, and non-transitory computer-readable medium described herein, for the second uplink control channel format, the sequence cyclic shift value includes a sequence cyclic shift associated with a QPSK mapping associated with a bit sequence of {0,0} for the zero-padded HARQ bit sequence, or a sequence cyclic shift associated with a QPSK mapping associated with a bit sequence of {1,0} for the zero-padded HARQ bit sequence.

In some examples of the method, network entities, and non-transitory computer-readable medium described herein, the first uplink control channel format includes a PUCCH format 0 and the second uplink control channel format includes a PUCCH format 1.

In some examples of the method, network entities, and non-transitory computer-readable medium described herein, decoding the UCI message may include operations, features, means, or instructions for decoding the UCI message in accordance with a first uplink control channel format or a second uplink control channel format that includes either a positive scheduling request or a negative scheduling request, where the sequence cyclic shift value may be based on the zero-padded HARQ bit sequence including the one bit of the HARQ information and one zero padding bit implied by the network entity.

In some examples of the method, network entities, and non-transitory computer-readable medium described herein, for the first uplink control channel format that includes the negative scheduling request, the sequence cyclic shift value includes a sequence cyclic shift value of 0 associated with a bit sequence of {0,0} for the zero-padded HARQ bit sequence, or a sequence cyclic shift value of 6 associated with a bit sequence of {1,0} for the zero-padded HARQ bit sequence.

In some examples of the method, network entities, and non-transitory computer-readable medium described herein, for the first uplink control channel format that includes the positive scheduling request, the sequence cyclic shift value includes a sequence cyclic shift value of 3 associated with a bit sequence of {0,0} for the zero-padded HARQ bit sequence, or a sequence cyclic shift value of 9 associated with a bit sequence of {1,0} for the zero-padded HARQ bit sequence.

In some examples of the method, network entities, and non-transitory computer-readable medium described herein, the first uplink control channel format includes a PUCCH format 0 and the second uplink control channel format includes a PUCCH format 1.

Some examples of the method, network entities, and non-transitory computer-readable medium described herein may further include operations, features, means, or instructions for outputting one or more messages that indicate an enablement or a disablement of a transmission scheme associated with the one or more zero-padding bits being implied by the network entity.

Some examples of the method, network entities, and non-transitory computer-readable medium described herein may further include operations, features, means, or instructions for outputting, to the UE, control signaling indicative of an activation or deactivation of a transmission scheme for the UCI message, where the transmission scheme may be based on a zero-padding configuration, an uplink channel and UCI payload multiplexing configuration, an uplink control channel format indication, or any combination thereof.

In some examples of the method, network entities, and non-transitory computer-readable medium described herein, the control signaling includes radio resource control signaling, a MAC-CE, a DCI message, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support techniques for handling hybrid automatic repeat request-acknowledgment (HARQ-ACK) codebook size mismatch in accordance with one or more aspects of the present disclosure.

FIGS. 3 and 4 show examples of HARQ-ACK codebook generation and transmission schemes that support techniques for handling HARQ-ACK codebook size mismatch in accordance with one or more aspects of the present disclosure.

FIG. 5 shows an example of a process flow that supports techniques for handling HARQ-ACK codebook size mismatch in accordance with one or more aspects of the present disclosure.

FIGS. 6 and 7 show block diagrams of devices that support techniques for handling HARQ-ACK codebook size mismatch in accordance with one or more aspects of the present disclosure.

FIG. 8 shows a block diagram of a communications manager that supports techniques for handling HARQ-ACK codebook size mismatch in accordance with one or more aspects of the present disclosure.

FIG. 9 shows a diagram of a system including a device that supports techniques for handling HARQ-ACK codebook size mismatch in accordance with one or more aspects of the present disclosure.

FIGS. 10 and 11 show block diagrams of devices that support techniques for handling HARQ-ACK codebook size mismatch in accordance with one or more aspects of the present disclosure.

FIG. 12 shows a block diagram of a communications manager that supports techniques for handling HARQ-ACK codebook size mismatch in accordance with one or more aspects of the present disclosure.

FIG. 13 shows a diagram of a system including a device that supports techniques for handling HARQ-ACK codebook size mismatch in accordance with one or more aspects of the present disclosure.

FIGS. 14 and 15 show flowcharts illustrating methods that support techniques for handling HARQ-ACK codebook size mismatch in accordance with one or more aspects of the present disclosure.

### DETAILED DESCRIPTION

Some wireless communications systems may support various hybrid automatic repeat request-acknowledgment (HARQ-ACK) protocols to enable communication of feedback for ongoing signaling within the network. For example, a device such as a user equipment (UE) may transmit HARQ-ACK feedback to a network entity (or multiple network entities) in order to acknowledge successful reception of downlink messages (e.g., with a “1” value HARQ bit), or to indicate that the UE had missed or otherwise failed to receive and/or decode the downlink messages (e.g., with a “0” value HARQ bit). The UE may then encode the HARQ-ACK information as a HARQ-ACK codebook (e.g., a sequence of one or more HARQ-ACK bits) in an uplink control information (UCI) message, and transmit the UCI in accordance with an encoding (e.g., a cyclic shift value, a quadrature phase shift keying (QPSK) encoding, a Reed-Muller encoding, a Polar coding) that the network entity may use to interpret the HARQ-ACK information.

In some cases, however, the UE may “miss” or fail to receive a downlink message transmitted by the network entity, and may transmit an incorrect number of HARQ information bits to the network entity when reporting the UCI. That is, there may be a mismatch in the number of HARQ bits that the network entity expects to receive, and the actual number of HARQ bits that the UE transmits. Some such HARQ-ACK mismatch challenges are especially impactful for small UCI payload sizes (e.g., 1 or 2 HARQ-ACK bit payloads), where the network entity may incorrectly interpret the transmitted HARQ bits. For example, the network entity may encounter a “2 to 1 error,” where the network entity expects a 2-bit HARQ from the UE, but only receives a 1 bit HARQ (due to the UE missing a last downlink message). In such cases, the UE transmits the UCI message in accordance with a cyclic shift value of 6 (or a cyclic shift determined by QPSK), which the network entity interprets as “11,” which is incorrect, since the UE did not correctly receive both messages, but instead received one and missed the other. Similar misinterpretations can also occur when the UE transmits two HARQ bits but was supposed to transmit three HARQ bits. In some other cases, the network entity may encounter a “more than 2 to one” error, where the network entity transmits more than 2 downlink messages, and expects to receive 2 or greater HARQ messages from the UE, but only receives one. Such errors may lead to a mismatch in interpretation of the HARQ, or decoding failure by the network entity.

To support more accurate decoding and interpretation of small HARQ codebook sizes, the UE and the network entity may support various explicit or implicit zero padding schemes for small HARQ-ACK payloads to align the HARQ codebook size to either 2 or 3 bits. By explicitly or implicitly padding HARQ-ACK payloads to 2 or 3 bits, such “2 to 1” and “more than 2 to 1” HARQ codebook size mismatches may be resolved, as reported HARQ-ACK feedback information explicitly or implicitly indicates that the UE did not successfully receive a last downlink message. In cases where the network only transmits one downlink message (and therefore only expects to receive one HARQ bit), then the additional HARQ bits that are explicitly/implicitly padded may simply be ignored by the network. Conversely, in cases where the network transmits two or more downlink messages (and therefore only expects to receive two or more HARQ bits), then the additional HARQ bits that are explicitly/implicitly padded may correctly indicate that the last downlink message(s) were not successfully received or decoded.

In some examples, the UE may explicitly pad the HARQ information to two or three bits, and may transmit the UCI according to a cyclic shift indicated for 2 or 3 bits (instead of 1 bit), which may allow the network entity to correctly interpret the HARQ information, either by a correct cyclic shift being used, or by using Reed-Muller encoding. In some other examples, the network entity may implicitly add zero padding to a HARQ bit transmitted by the UE, so that the network entity may correctly interpret the UCI.

Aspects of the disclosure may be implemented to realize one or more potential advantages. For example, by using techniques to improve the accuracy of encoding and interpretation of small HARQ-ACK payloads, the communications accuracy for signaling between UEs and associated network entities may be improved. For example, if a network entity 105 is able to more accurately interpret HARQ-ACK information, the network entity may be able to more appropriately react to HARQ-ACK information from the UE (e.g., the network entity may perform retransmissions of information to the UE when the UE indicates a missed downlink control information (DCI)). Additionally, or alternatively, the accurate interpretation of HARQ-ACK information may allow for reduced signaling overhead, as the network entity may be less likely to incorrectly determine non-acknowledgments (NACK) transmitted by the UE. Additionally, or alternatively, the techniques described herein may allow for flexibility in configuring a HARQ-ACK scheme based on a determined likelihood of DCI misdetection (e.g., zero-padding techniques may be enabled for a high likelihood of DCI misdetection, and may be disabled for a low likelihood of DCI misdetection), which may allow for reduced complexity and power expenditure for a UE.

Aspects of the disclosure are initially described in the context of wireless communications systems. Aspects of the disclosure are further illustrated by and described with reference to HARQ-ACK codebook generation and transmission schemes, a process flow, apparatus diagrams, system diagrams, and flowcharts that relate to techniques for handling HARQ-ACK codebook size mismatch.

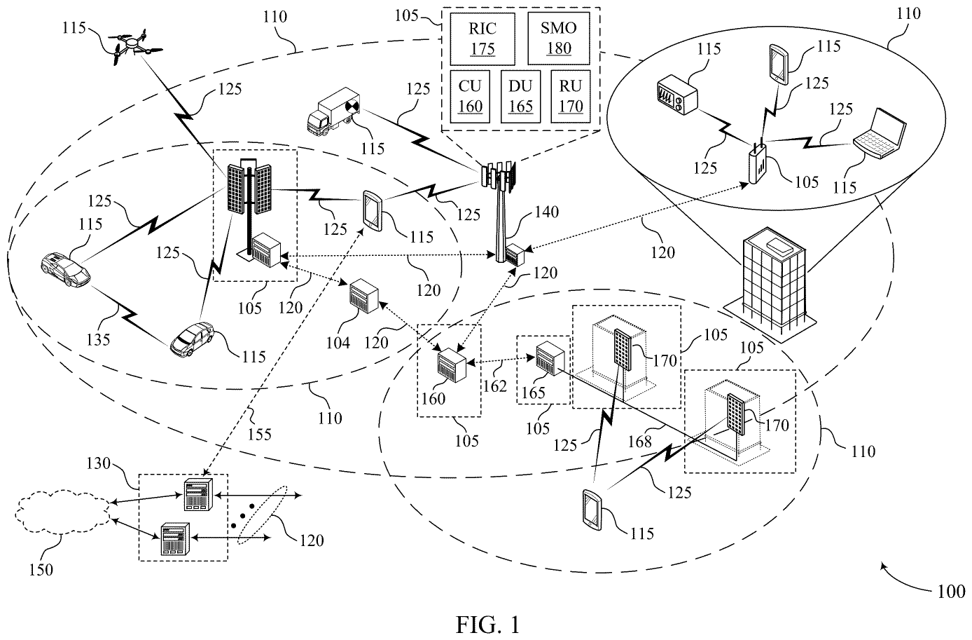

FIG. 1 shows an example of a wireless communications system 100 that supports techniques for handling HARQ-ACK codebook size mismatch in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for handling HARQ-ACK codebook size mismatch as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support various HARQ-ACK protocols to enable communication of feedback for ongoing signaling within the network. For example, a UE 115 may transmit HARQ-ACK feedback to a network entity 105 in order to acknowledge successful reception of downlink messages (e.g., with a “1” value HARQ bit), or to indicate that the UE 115 had missed or failed to receive the downlink messages (e.g., with a “0” value HARQ bit). The UE 115 may then encode the HARQ-ACK information as a HARQ-ACK codebook (e.g., a sequence of one or more HARQ-ACK bits) in a UCI message, and transmit the UCI in accordance with an encoding (e.g., a cyclic shift value, a QPSK encoding, a Reed-Muller encoding, a Polar coding) that the network entity 105 may use to interpret the HARQ-ACK information.

In some cases, however, there may be a mismatch in the number of HARQ bits that the network entity 105 expects to receive, and the actual number of HARQ bits that the UE 115 transmits. Some such HARQ-ACK mismatch challenges are especially impactful for small UCI payload sizes (e.g., 1 or 2 HARQ-ACK bit payloads), where the network entity 105 may incorrectly interpret the transmitted HARQ bits.

To support more accurate decoding and interpretation of small HARQ codebook sizes, the UE 115 and the network entity 105 may support various different explicit or implicit zero padding schemes for small HARQ-ACK payloads to align the HARQ codebook size to either 2 or 3 bits. In some examples, the UE 115 may explicitly pad the HARQ information to two or three bits, and may transmit the UCI according to a cyclic shift indicated for 2 or 3 bits (instead of 1 bit), which may allow the network entity 105 to correctly interpret the HARQ information, either by a correct cyclic shift being used, or by using Reed-Muller encoding. In some other examples, the network entity 105 may implicitly add zero padding to a HARQ bit transmitted by the UE 115, so that the network entity 105 may correctly interpret the UCI.

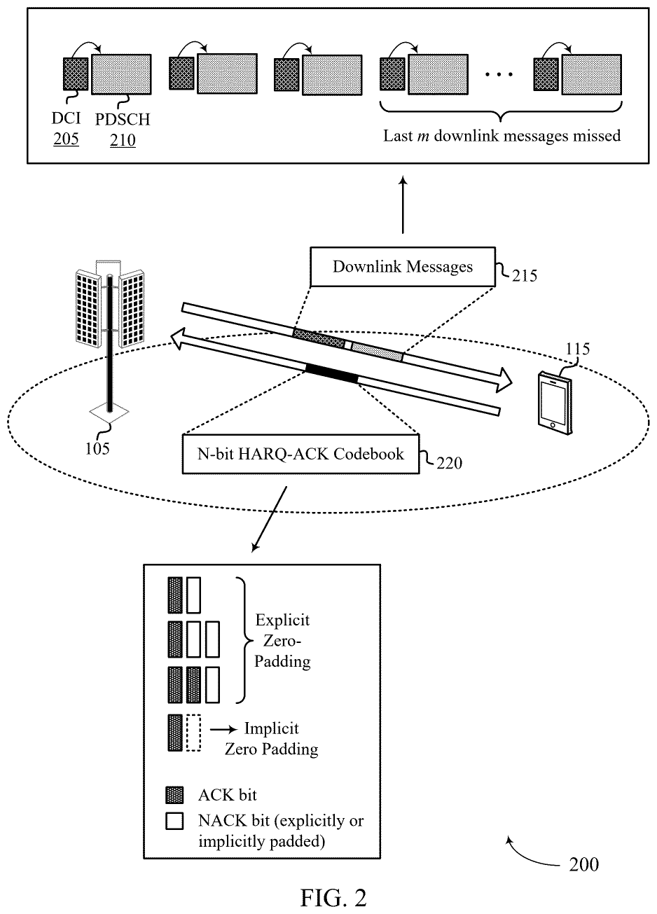

FIG. 2 shows an example of a wireless communications system 200 that supports techniques for handling HARQ-ACK codebook size mismatch in accordance with one or more aspects of the present disclosure. For example, the wireless communications system 200 may support communications between a UE 115 and a network entity 105, each of which may be examples of corresponding devices described with reference to FIG. 1. In some aspects, the UE 115 and the network entity 105 may support techniques for accurate encoding and decoding of relatively short HARQ-ACK codebook sizes (e.g., HARQ-ACK codebooks having 2 or fewer bits).

The wireless communications system 200 may implement a HARQ-ACK protocol such that a HARQ-ACK process (relating to a downlink transmission) may be explicitly signaled as part of DCI 205 received by the UE 115. The HARQ-ACK mechanism may be supported at the MAC layer, targeting fast retransmissions and, consequently, fast feedback relating to the whether the UE 115 has successfully (or unsuccessfully) received a downlink transmission (including DCI 205, and/or a PDSCH transmission 210). In some aspects, the UE 115 may transmit HARQ-ACK feedback after each received transport block in order to inform the network entity 105 about the information successfully received or decoded by the UE 115.

In some implementations, the UE 115 may construct a HARQ-ACK codebook 220 which includes a sequence of bits, including bits that indicate either ACK or NACK feedback of multiple (e.g., two or more) downlink messages 215 received for configured time window, and may transmit the HARQ-ACK codebook 220 via uplink control information (UCI) signaling. In some cases, the UE 115 may perform channel coding for UCI transmissions of the HARQ-ACK codebook 220, where the channel coding may be based on the size of the HARQ-ACK codebook 220 (e.g., the quantity of bits included in the HARQ-ACK codebook 220). For example, the UE 115 may perform repetition coding if the HARQ-ACK codebook 220 is less than or equal to 2 bits, Reed-Muller (RM) coding if the HARQ-ACK codebook 220 is between 3 bits and 11 bits, polar coding if the HARQ-ACK codebook size is greater than or equal to 12 bits, among other channel coding types.

The UE 115, however, in some cases, may erroneously fail to receive (or fail to decode) one or more downlink grants or DCI transmitted from the network entity 105 (e.g., m downlink grants or m DCI may be missed). In such cases, the HARQ-ACK codebook 220 that the UE 115 constructs may have a quantity of bits that is different from a quantity of bits that the network entity 105 expects to receive from the UE 115.

For example, if the network entity 105 transmits 3+m DCI (and a corresponding 3+m PDSCHs scheduled by the 3+m DCIs) and the UE 115 receives the first 3 DCI but fails to receive or decode the last m DCIs, the UE 115 may construct a HARQ-ACK codebook of “101” bits (indicating reception of the first 3 DCIs), and may transmit the HARQ-ACK codebook of “101” to the network entity 105. The network entity 105, however, may be unable to correctly interpret the received HARQ-ACK codebook (or may only by luck be able to correctly interpret the received HARQ-ACK codebook), since the network entity 105 expects a HARQ-ACK codebook of “101 . . . 0” accounting for the last m DCIs that the UE 115 missed. In some examples, if the UE 115 encodes the HARQ-ACK codebook using RM coding, the additional bits that are not sent by the UE 115 may be interpreted as “NACK” by the network entity 105, which may not cause challenges for the network-side interpretation. If the UE 115 encodes the HARQ-ACK codebook 220 using a different encoding scheme, however (such as polar coding) the network entity 105 may be unable to decode the HARQ-ACK codebook 220 due to the incorrect HARQ-ACK codebook size assumption.

In some aspects, the UE 115 may transmit UCI having a HARQ-ACK codebook size of less than or equal to 2 bits via a physical uplink control channel (PUCCH) or a physical uplink shared channel (PUSCH). For transmissions of the UCI via PUCCH, the UE 115 may use PUCCH Format 0 (PF0) or PUCCH Format 1 (PF1). For examples in which the UE 115 transmits the HARQ-ACK codebook 220 via PF0, and there is no overlap between the PUCCH and another PUCCH that includes a scheduling request (SR), the UE 115 may apply cyclic shift values of a Zadoff-Chu sequence to the HARQ-ACK feedback to map the values of the HARQ-ACK information bits to sequences of the PUCCH format. For example, for a 1-bit HARQ-ACK codebook, if a HARQ-ACK bit has a value of 0, the UE 115 may use a sequence cyclic shift value (mcs) of 0, and if a HARQ-ACK bit has a value of 1, the UE 115 may use a sequence cyclic shift value of 6. In some other examples, for a 2-bit HARQ-ACK codebook, if the HARQ-ACK codebook has bit values {0,0}, the UE 115 may use a sequence cyclic shift value (mcs) of 0, if the HARQ-ACK codebook has bit values {0,1}, the UE 115 may use a sequence cyclic shift value of 3, if the HARQ-ACK codebook has bit values {1,1}, the UE 115 may use a sequence cyclic shift value of 6, and if the HARQ-ACK codebook has bit values {1,0}, the UE 115 may use a sequence cyclic shift value of 9.

In some other examples, in which the UE 115 transmits the HARQ-ACK codebook with an overlap between the PUCCH and another PUCCH that includes the SR, the UE 115 may apply cyclic shift values of a Zadoff-Chu sequence to the HARQ-ACK feedback to map the values of the HARQ-ACK information bits to sequences of the PUCCH format. For example, for a 1-bit HARQ-ACK codebook, if a HARQ-ACK bit has a value of 0 with a negative SR (0,n), the UE 115 may use a sequence cyclic shift value of 0, if a HARQ-ACK bit has a value of 1 with a negative SR (1,n), the UE 115 may use a sequence cyclic shift value of 6, if a HARQ-ACK bit has a value of 0 with a positive SR (0,p), the UE 115 may use a sequence cyclic shift value of 3, and if a HARQ-ACK bit has a value of 1 with a positive SR (1,p), the UE 115 may use a sequence cyclic shift value of 9. In some other examples, for a 2-bit HARQ-ACK codebook, if the HARQ-ACK codebook has a value of 00 with a negative SR (00,n), the UE 115 may use a sequence cyclic shift value of 0, if the HARQ-ACK codebook has a value of 10 with a negative SR (10,n), the UE 115 may use a sequence cyclic shift value of 9, if the HARQ-ACK codebook has a value of 00 with a positive SR (00,p), the UE 115 may use a sequence cyclic shift value of 1, the HARQ-ACK codebook has a value of 10 with a positive SR (10,p), the UE 115 may use a sequence cyclic shift value of 10, if the HARQ-ACK codebook has a value of 01 with a negative SR (01,n), the UE 115 may use a sequence cyclic shift value of 3, if the HARQ-ACK codebook has a value of 11 with a negative SR (11,n), the UE 115 may use a sequence cyclic shift value of 6, if the HARQ-ACK codebook has a value of 01 with a positive SR (01,p), the UE 115 may use a sequence cyclic shift value of 4, and if the HARQ-ACK codebook has a value of 11 with a positive SR (11,p), the UE 115 may use a sequence cyclic shift value of 7.

In some other implementations, if the UE 115 transmits the HARQ-ACK codebook using a PUCCH format 1 (e.g., PF1), the UE 115 may use either BPSK or QPSK modulation for encoding the HARQ-ACK codebook. For example, for a 1-bit HARQ-ACK codebook (e.g., k=1), if the HARQ-ACK bit value is “0,” then the HARQ-ACK encoding may have a value of

$$\frac{1}{\sqrt{2}} ( + 1 + j ) ,$$

and if the HARQ-ACK bit value is “1,” then the encoding may have a value of

$$\frac{1}{\sqrt{2}} ( - 1 - j ) .$$

Additionally, or alternatively, for a 2-bit HARQ-ACK codebook (e.g., k=2), if the HARQ-ACK bit value is “00,” then the HARQ-ACK encoding may have a value of

$$\frac{1}{\sqrt{2}} ( + 1 + j ) ,$$

if the HARQ-ACK bit value is “01,” then the encoding may have a value of

$$\frac{1}{\sqrt{2}} ( + 1 - j ) ,$$

and if the HARQ-ACK bit value is “10,” then the encoding may have a value of

$$\frac{1}{\sqrt{2}} ( - 1 + j ) ,$$

and it the HARQ-ACK bit value is “11,” then the encoding may have a value of

$$\frac{1}{\sqrt{2}} ( - 1 - j ) .$$

Additionally, or alternatively, if the UE 115 transmits the HARQ-ACK codebook via the PUSCH, the UE 115 may use repetition coding, which may depend on the modulation order of the PUSCH (e.g., for QPSK and repetition coding of size 6, “1” may be encoded as “111111,” and “10” may be encoded as “101101.”

In some aspects, the different encoding techniques that the UE 115 may use for encoding and transmitting the HARQ-ACK codebook may allow for HARQ-ACK codebook size mismatch at the UE 115 and the network entity 105 in cases that the UE 115 misses (or fails to correctly decode) one or more downlink grants (e.g., DCI 205, downlink messages 215) transmitted by the network entity 105. The HARQ-ACK codebook size mismatch may cause various challenges for the network entity 105 (e.g., interpreting the HARQ-ACK codebook) and for the UE 115, if the network entity 105 incorrectly interprets the HARQ-ACK codebook.

One such challenge may be a “2 to 1 error,” in which a 2-bit HARQ-ACK is assumed by the network entity 105, but only a 1-bit HARQ-ACK codebook is sent by the UE 115. For example, if the UE 115 transmits UCI over PUCCH Format 0 (PF0) and the network entity 105 expects to receive a 2-bit HARQ-ACK codebook from the UE 115, but the UE 115 misses (e.g., fails to correctly decode) the last DCI and only sends a 1-bit HARQ-ACK codebook to the network entity 105, then the UE may select a cyclic shift of 6 to encode the single bit. The network entity, however, may interpret this cyclic shift as “11,” (e.g., “11” is the bit value corresponding to a cyclic shift value of 6 for a 2 bit HARQ-ACK codebook, rather than a single HARQ-ACK codebook) which would be incorrect the last DCI was missed by the UE 115, and network entity should have picked “10,” which would be a correct interpretation of the HARQ-ACK codebook 220 transmitted by the UE 115.

In some other examples, the network entity 105 and the UE 115 may encounter the “2 to 1 error” if the UE 115 transmits UCI via PUCCH Format 1 (PF1), and the network entity 105 expects to receive a 2-bit HARQ-ACK codebook from the UE 115, but the UE 115 misses the last DCI and only sends a 1-bit HARQ-ACK codebook to the network entity 105. In such cases, the UE may select an encoding of

$$\frac{1}{\sqrt{2}} ( - 1 - j ) ,$$

which the network entity 105 may interpret as “11” which is an incorrect interpretation, because the UE missed the last DCI, and the network entity 105 should have interpreted the HARQ-ACK codebook as “10.” In some other examples, the network entity 105 and the UE 115 may encounter the “2 to 1 error” if the UE 115 transmits the UCI via the PUSCH, and the network entity 105 expects to receive a 2-bit HARQ-ACK codebook from the UE 115, but the UE 115 misses (e.g., fails to correctly decode) the last DCI. In such cases, the UE 115 may transmit a 1-bit HARQ-ACK codebook to the network entity, and depending on the modulation order of the PUSCH and the output size of the repetition coding, the network entity 105 may misinterpret the HARQ-ACK codebook. For example, if the UE 115 performs QPSK modulation for 6 coded bits, “1” may result in coded bits ‘111111,’ while “10” results in coded bits ‘101101,’ which are not the same, and which may cause an interpretation error by the network entity 105.

Another challenge that the UE 115 and the network entity 105 may encounter due to small HARQ-ACK codebook size may be a “more than 2 error to 2 or 1 error,” in which a 2-bit or 1-bit HARQ-ACK codebook is transmitted by the UE 115, which the network entity 105 interprets as a more than 2-bit HARQ-ACK codebook. For example, if the UE 115 transmits UCI via the PUCCH and the network entity 105 expects to receive a more than 2-bit HARQ-ACK codebook from the UE 115, but the UE misses (e.g., fails to correctly decode) one or more last DCIs and sends a 2-bit or 1-bit HARQ-ACK codebook to the network entity 105, then the PUCCH format and resource may be different. Additionally, or alternatively, if the UE 115 transmits UCI via the PUSCH, and the network entity 105 expects to receive a more than 2-bit HARQ-ACK codebook from the UE 115 (but the UE 115 misses the last one or more DCIs and transmits a 2-bit or 1-bit HARQ-ACK codebook to the network entity 105) then the UE 115 may use repetition coding for encoding the UCI, while the network entity 105 uses Reed Muller or polar coding schemes to decode the UCI. Such mismatch in encoding and decoding schemes may result in the network entity erroneously interpreting the received HARQ-ACK codebook, or declaring all NACK for the received HARQ-ACK codebook.

To reduce the likelihood of HARQ-ACK codebook size mismatch, and the related errors in HARQ-ACK codebook interpretation, the UE 115 and the network entity 105 may support various different encoding and decoding techniques, including use of zero-padding for the HARQ-ACK codebook, and use of Reed-Muller encoding. For example, when the UCI payload is between 3 and 11 bits, the UE 115 may use Reed-Muller encoding for encoding the HARQ-ACK codebook. In some aspects, in cases of HARQ-ACK codebook mismatch between the HARQ-ACK codebook that the UE 115 transmits and the HARQ-ACK codebook that the network entity 105 expects, the bits that are expected by the network entity 105 (but not sent by the UE 115) may be zero padded based on properties of the Reed-Muller encoding, which may allow the network entity 105 to correctly decode the HARQ-ACK bits transmitted by the UE 115. For example, if the HARQ-ACK codebook at UE 115 is “1101” and the network entity 105 expects a 5-bit HARQ-ACK codebook, then the network entity 105 may be able to decode the first 4 bits by appending a “0” to the received HARQ-ACK codebook (e.g., “11010”), and then determines that the last DCI was missed by the UE 115.

In some implementations, the UE 115 and the network entity 105 may utilize use the zero-padding property of Reed-Muller codes (e.g., zero padding the received HARQ-ACK codebook until the size matches what is expected by the network entity 105) so that the network entity 105 is less likely to misinterpret the HARQ-ACK codebook (and/or is less likely to declare all bits as NACK). In some examples, for a UCI payload of less than or equal to 2 bits, the UE may support a zero-padding algorithm to align the size of the HARQ-ACK codebook to 2 bits or 3 bits. In some aspects, the zero-padding algorithm may be an explicit zero padding algorithm in which the UE 115 explicitly appends zeros to the HARQ-ACK codebook, and uses different cyclic shifts or QPSK-based mappings to transmit the HARQ-ACK codebook. In some other examples, the zero-padding algorithm may be an implicit zero-padding algorithm, in which the network entity 105 implicitly adds zero-padding bits to a received HARQ-ACK codebook prior to interpreting the codebook.

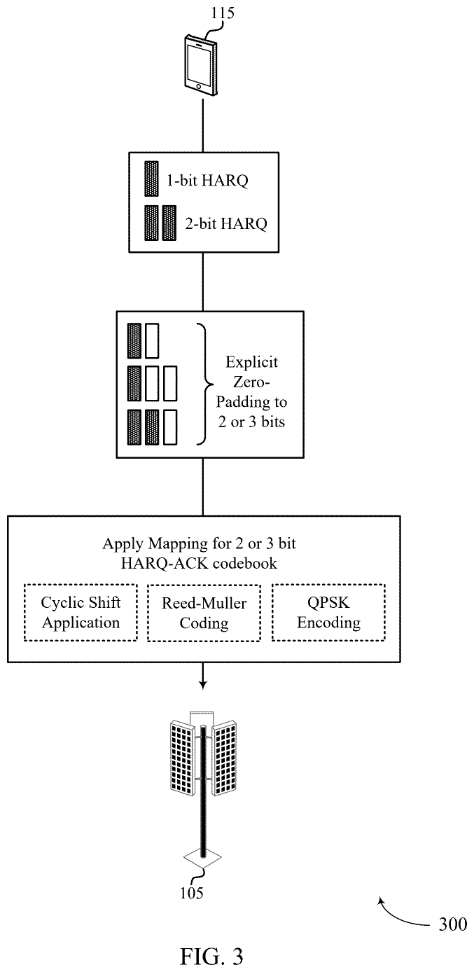

FIG. 3 shows an example of a HARQ-ACK codebook generation and transmission scheme 300 that supports techniques for handling HARQ-ACK codebook size mismatch in accordance with one or more aspects of the present disclosure. For example, the HARQ-ACK codebook generation and transmission scheme 300 may support communications between a UE 115 and a network entity 105, each of which may be examples of corresponding devices described with reference to FIGS. 1 and 2. In some aspects, the UE 115 and the network entity 105 may support techniques for accurate encoding and decoding of relatively short HARQ-ACK codebook sizes (e.g., HARQ-ACK codebooks having 2 or fewer bits).

To improve the interpretation accuracy for HARQ-ACK codebooks having less than or equal to 2 bits, the UE 115 may apply a zero padding algorithm to align the size of the HARQ-ACK codebook size to either 2 bits or 3 bits, which may reduce the likelihood of “2 to 1” error (e.g., where the UE 115 transmits a 1-bit HARQ-ACK, but the network entity 105 expects a 2 bit HARQ-ACK codebook). In some examples where the UE 115 transmits UCI via PF0 or PF1 without a scheduling request (SR) included in the payload of UCI, the UE 115 may support an explicit zero padding, in which the UE 115 explicitly pads the UCI with zeros (e.g., NACK bits) to align a 1-bit HARQ-ACK codebook to a 2-bit size (or a 2-bit HARQ-ACK codebook to a 3-bit size, among other zero-padding options). For example, if the HARQ-ACK codebook size at UE 115 is 1 bit, the UE 115 may append a “0” to the 1-bit HARQ-ACK codebook, and may use mappings for the 2-bit HARQ-ACK codebook size (e.g., the UE 115 may use a table for cyclic shifts applied to 2 bits in PF0, or a QPSK-based mapping for PF1). For example, the UE 115 may use a mapping illustrated in Table 1 below to determine a sequence cyclic shift to apply to the padded 2-bit HARQ-ACK payload in PF0:

TABLE 1
Mapping of 2 HARQ-ACK information bits
to sequences for PUCCH format 0

| HARQ-ACK Value | {0, 0} | {0, 1} | {1, 1} | {1, 0} |
|---|---|---|---|---|
| Sequence Cyclic Shift | m_{CS} = 0 | m_{CS} = 3 | m_{CS} = 6 | m_{CS} = 9 |

and for overlapping PUCCH and SR PUCCH (e.g., SR included in the payload of the UCI), the UE 115 may use a mapping illustrated in Table 2 below to determine a sequence cyclic shift to apply to the padded 2-bit HARQ-ACK payload in PF0:

TABLE 2
Mapping of 2 HARQ-ACK information bits
to sequences for PUCCH format 0

| | k = 2 | | | | | | | |
|---|---|---|---|---|---|---|---|---|
| | (00, | (10, | (00, | (10, | (01, | (11, | (01, | (11, |
| | n) | n) | p) | p) | n) | n) | p) | p) |
| Cyclic Shift | 0 | 9 | 1 | 10 | 3 | 6 | 4 | 7 |

where k is the quantity of HARQ-ACK bits, n indicates a negative scheduling request, and p indicates a positive scheduling request. For the QPSK modulation, for a 2-bit HARQ-ACK codebook (e.g., k=2), if the HARQ-ACK bit value is “00,” then the HARQ-ACK encoding may have a value of

$$\frac{1}{\sqrt{2}} ( + 1 + j ) ,$$

if the HARQ-ACK bit value is “01,” then the encoding may have a value of

$$\frac{1}{\sqrt{2}} ( + 1 - j ) ,$$

if the HARQ-ACK bit value is “10,” then the encoding may have a value of

$$\frac{1}{\sqrt{2}} ( - 1 + j ) ,$$

and if the HARQ-ACK bit value is “11,” then the encoding may have a value of

$$\frac{1}{\sqrt{2}} ( - 1 - j ) .$$

In some examples, the UE 115 may maintain Grey coding for the 2-bit CB size, but performance of 1-bit CB size (in cases of no CB size mismatch) may be affected as the maximum distance (for PF0, the maximum distance between cyclic shifts and for PF1, the maximum Euclidean distance between constellation points) is reduced. In such examples, the UE 115 may not use the mappings for a 1-bit HARQ-ACK codebook, and may instead use the 2-bit HARQ-ACK codebook mappings.

In some other implementations, to address the “more than 2 to 2 or 1 error” (e.g., when the network entity 105 expects to receive a more than 2-bit HARQ-ACK codebook from the UE 115 but receives a 2-bit or 1-bit HARQ-ACK codebook from the UE 115), the UE 115 may explicitly zero-pad the HARQ-ACK codebook until the codebook size becomes 3 bits and then the UE 115 may use a Reed-Muller code to encode the HARQ-ACK codebook. In some examples, if the UE 115 multiplexes the UCI with a PUSCH, the UE 115 may perform zero-padding and then may use Reed-Muller encoding to encode the UCI payload size. In some examples, if the UE 115 transmits the UCI via PUCCH (and since the zero-padded HARQ-ACK codebook has a 3 bit size), the UE 115 may use PUCCH formats 2, 3, or 4. In some such examples, the network entity 105 may enable use of the PUCCH formats 2, 3, or 4 if reducing missed DCIs is prioritized over uplink signal to interference plus noise ratio (SINR) coverage.

In some aspects, the network entity 105 may indicate or configure whether the UE 115 multiplexes the UCI with the PUSCH (with Reed-Muller encoding) or whether the UE 115 transmits the UCI via the PUCCH via PUCCH formats 2, 3, or 4 via RRC signaling, MAC-CE signaling, or DCI signaling (e.g., downlink DCI in cases of PUCCH and uplink DCI in cases of PUSCH). In some examples, a downlink DCI may enable or disable the transmission of the UCI via the PUCCH, and a flag included in the DCI, and/or an indication of a PUCCH resource or PUCCH resource set may indicate the enabling or disabling of the transmission of the UCI via the PUCCH. For example, if the network entity 105 indicates PF0 or PF1 for a PUCCH resource, then the UE 115 may not perform explicit zero padding of the HARQ-ACK codebook to 3 bits, but if the network entity 105 indicates other PUCCH formats (e.g., PUCCH formats 2, 3, 4), then the UE 115 may perform the explicit zero-padding of the HARQ-ACK codebook to 3 bits.

In some aspects, the UE 115 may receive an indication to switch between explicit zero-padding of the HARQ-ACK codebook and no zero-padding. In other words, the network may indicate whether or not explicit zero-padding is enabled or disabled. For example, the UE 115 may receive the indication via RRC signaling, MAC-CE signaling, DCI signaling (e.g., downlink DCI format that schedules HARQ-ACK may enable or disable the explicit zero-padding behavior by the UE 115). In such cases, the network entity 105 may evaluate network conditions and other factors to determine whether to enable or disable the explicit zero-padding (e.g., if the network entity 105 determines that the likelihood of DCI misdetection is low, the network entity 105 may disable the zero-padding behavior, and if the network entity 105 determines that the likelihood of DCI misdetection is high, the network entity 105 may enable the zero-padding behavior).

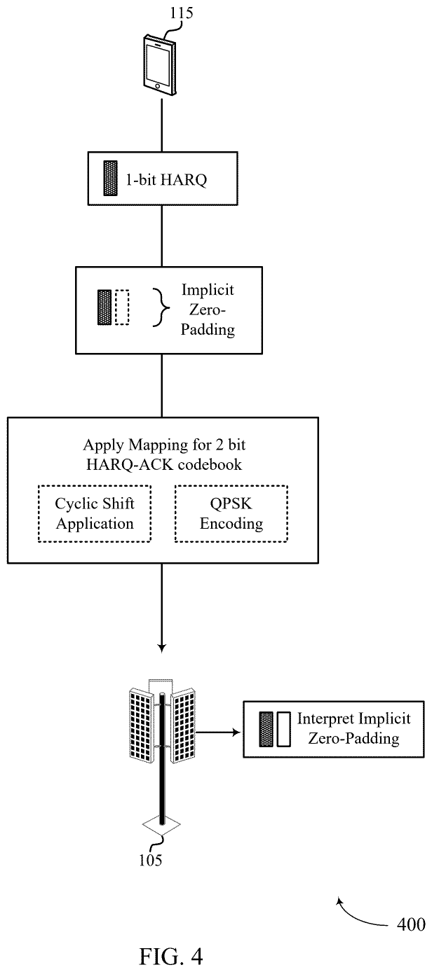

FIG. 4 shows an example of a HARQ-ACK codebook generation and transmission scheme 400 that supports techniques for handling HARQ-ACK codebook size mismatch in accordance with one or more aspects of the present disclosure. For example, the HARQ-ACK codebook generation and transmission scheme 400 may support communications between a UE 115 and a network entity 105, each of which may be examples of corresponding devices described with reference to FIGS. 1 through 3. In some aspects, the UE 115 and the network entity 105 may support techniques for accurate encoding and decoding of relatively short HARQ-ACK codebook sizes (e.g., HARQ-ACK codebooks having 2 or fewer bits).

To improve the interpretation accuracy for HARQ-ACK codebooks having less than or equal to 2 bits, the UE 115 may support implicit zero padding, which may align the size of the HARQ-ACK codebook size to either 2 bits or 3 bits, which may reduce the likelihood of “2 to 1” error (e.g., where the UE 115 transmits a 1-bit HARQ-ACK, but the network entity 105 expects a 2 bit HARQ-ACK codebook). For example, the network entity 105 and the UE 115 may support a mapping of a 2-bit HARQ-ACK codebook size such that there is no distance difference between “1” versus “10,” and also no difference between “0” and “00.” That is, if the UE 115 transmits a 1-bit HARQ-ACK codebook of “1,” the 1 may be “implicitly zero-padded” in such a way that the network entity 105 may interpret the “1” as “10,” and if the UE 115 transmits a 1-bit HARQ-ACK codebook of “0,” the network entity 105 may interpret the “0” as “00.” In some such examples, the UE 115 may use mappings for a 2-bit HARQ-ACK codebook size (e.g., the UE 115 may use a table for cyclic shifts applied to 2 bits in PF0, or a QPSK-based mapping for PF1). For example, the UE 115 may use a mapping illustrated in Table 3 below to determine a sequence cyclic shift to apply to the HARQ-ACK payload in PF0:

TABLE 3
Mapping of 2 HARQ-ACK information bits
to sequences for PUCCH format 0

| HARQ-ACK Value | {0, 0} | {0, 1} | {1, 0} | {1, 1} |
|---|---|---|---|---|
| Sequence Cyclic Shift | m_{CS} = 0 | m_{CS} = 3 | m_{CS} = 6 | m_{CS} = 9 |

For PF1, the UE 115 may swap the bits to symbol mapping of “11” and “10” for QPSK modulation, so that For PF1, swap the bits to symbol mapping of “11” and “10” (e.g., “10” may be mapped to

$$\frac{1}{\sqrt{2}} ( - 1 - j )$$

and “11” may be mapped to

$$\frac{1}{\sqrt{2}} ( - 1 + j ) ,$$

while “00,” may be mapped to

$$\frac{1}{\sqrt{2}} ( + 1 + j ) ,$$

and “01,” may be mapped to

$$\frac{1}{\sqrt{2}} ( + 1 - j ) .$$

In some other examples, the UE 115 and the network entity 105 may support implicit zero padding of the HARQ-ACK codebook such that a HARQ-ACK codebook of “0” is the same as “00,” and a HARQ-ACK codebook of “1” is the same as “10” for both positive and negative SRs. The UE 115 may use a mapping illustrated in Table 4 below to determine a sequence cyclic shift to apply to the HARQ-ACK payload in PF1:

TABLE 4
Mapping of 2 HARQ-ACK information bits
to sequences for PUCCH format 1

| | k = 2 | | | | | | | |
|---|---|---|---|---|---|---|---|---|
| | (00, | (10, | (00, | (10, | (01, | (11, | (01, | (11, |
| | n) | n) | p) | p) | n) | n) | p) | p) |
| Cyclic Shift | 0 | 6 | 3 | 9 | 1 | 7 | 4 | 10 |

where k is the quantity of HARQ-ACK bits, n indicates a negative scheduling request, and p indicates a positive scheduling request. In such cases, the cyclic shifts of the first four two-bit HARQ-ACK codebooks may be the same as the 1 bit-HARQ-ACK codebook mappings illustrated in Table 5 in PF1:

TABLE 5
Mapping of 1 HARQ-ACK information
bit to sequences for PUCCH format 1

| k = 1 | (0, n) | (1, n) | (0, p) | (1, p) |
|---|---|---|---|---|
| Cyclic Shift | 0 | 6 | 3 | 9 |

where k is the quantity of HARQ-ACK bits, n indicates a negative scheduling request, and p. indicates a positive scheduling request.

In some aspects, the UE 115 may receive an indication to switch between implicit zero-padding of the HARQ-ACK codebook and no implicit zero-padding, in addition to an indication for enabling or disabling SR. For example, the UE 115 may receive one or both indications via RRC signaling, MAC-CE signaling, DCI signaling (e.g., downlink DCI format that schedules HARQ-ACK may enable or disable the explicit zero-padding behavior by the UE 115). In such cases, the network entity 105 may evaluate network conditions and other factors to determine whether to enable or disable the implicit zero-padding (e.g., if the network entity 105 determines that the likelihood of DCI misdetection is low, the network entity 105 may disable the implicit zero-padding behavior, and if the network entity 105 determines that the likelihood of DCI misdetection is high, the network entity 105 may enable the implicit zero-padding behavior).

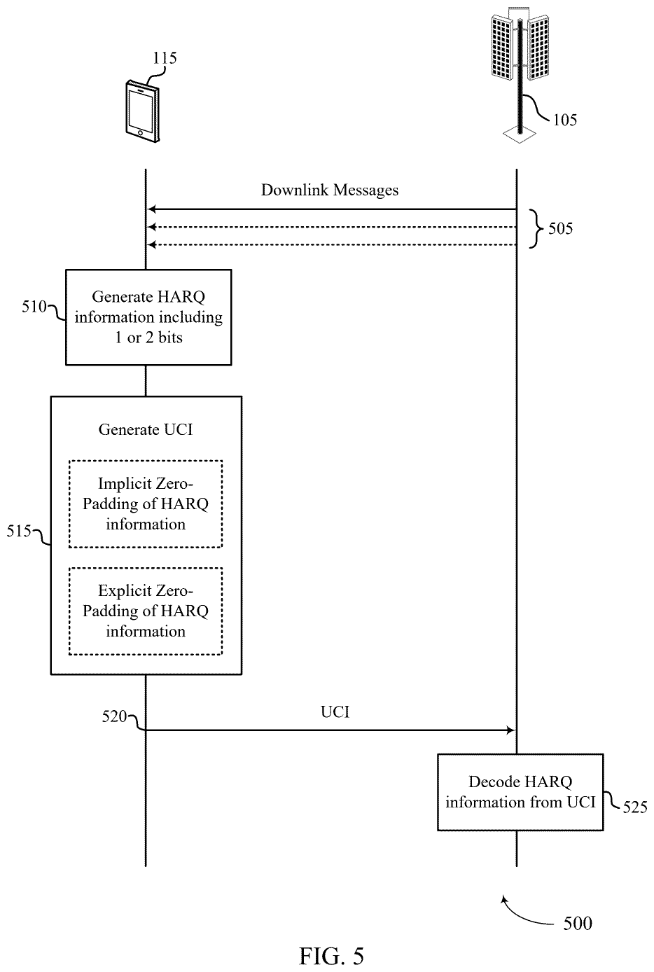

FIG. 5 shows an example of a process flow 500 that supports techniques for handling HARQ-ACK codebook size mismatch in accordance with one or more aspects of the present disclosure. For example, the process flow 500 may illustrate a process flow or communications flow between a UE 115 (e.g., which may be an example of UEs 115 described with reference to FIGS. 1 through 4) and a network entity 105 (e.g., which may be an example of network entities 105 described herein).

Alternative examples of the following may be implemented. Some steps are performed in a different order than described herein or are not performed at all. In some implementations, steps may include additional features not mentioned below, or additional steps may be added. Further, although the UE 115 and the network entity 105 are illustrated performing the operations of the process flow 500, some aspects of some operations may also be performed by one or more other network functions, network entities, or wireless communications devices.

At signal flow operation 505, the UE 115 may receive, from the network entity 105, one or more downlink messages.

At operation 510, the UE 115 may generate one-bit or two-bits of HARQ information corresponding to respective downlink messages of the one or more downlink messages.

At operation 515, the UE 115 may generate a UCI message by appending one or more zero-padding bits to the HARQ information to generate a zero-padded HARQ bit sequence (e.g., based on the HARQ information including one or two bits). In some aspects, the payload size of the zero-padded HARQ bit sequence may include two bits if the HARQ information originally included one bit, or three bits if the HARQ information originally included one bit or two bits.

At signal flow operation 520, the UE 115 may transmit the UCI message in accordance with a sequence cyclic shift value corresponding to the payload size of the zero-padded HARQ bit sequence.

In some examples, the HARQ information may include one bit, and the payload size of the zero-padded HARQ bit sequence may include two bits, and the UE 115 may transmit the UCI message in accordance with a first uplink control channel format (e.g., PF0) or a second uplink control channel format (e.g., PF1) that does not include a scheduling request. In such examples, the UE 115 may apply a sequence cyclic shift value that is based on the one bit of the HARQ information and one zero padding bit included in the zero-padded HARQ bit sequence. For example, for the first uplink control channel format (e.g., PF0), the sequence cyclic shift value may include a sequence cyclic shift value of 0 associated with a bit sequence of {0,0} for the zero-padded HARQ bit sequence, or a sequence cyclic shift value of 9 associated with a bit sequence of {1,0} for the zero-padded HARQ bit sequence. For the second uplink control channel format (e.g., PF1), the sequence cyclic shift value may include a sequence cyclic shift associated with a QPSK mapping associated with a bit sequence of {0,0} for the zero-padded HARQ bit sequence, or a sequence cyclic shift associated with a QPSK mapping associated with a bit sequence of {1,0} for the zero-padded HARQ bit sequence.

In some aspects, the HARQ information includes one bit, and the payload size of the zero-padded HARQ bit sequence includes two bits, and the UE 115 may transmit the UCI message in accordance with a first uplink control channel format or a second uplink control channel format that includes either a positive scheduling request or a negative scheduling request. In such aspects, the UE 115 may apply a sequence cyclic shift value that is based on the one bit of the HARQ information and one zero padding bit included in the zero-padded HARQ bit sequence. In some examples where the first uplink control channel format (e.g., PF0) includes a negative scheduling request, the sequence cyclic shift may be 0 for a bit sequence of {0,0} for the zero-padded HARQ bit sequence, or the sequence cyclic shift may be 9 for a bit sequence of {1,0} for the zero-padded HARQ bit sequence. In some examples where the first uplink control channel format includes a positive scheduling request, the sequence cyclic shift may be 1 for a bit sequence of {0,0} for the zero-padded HARQ bit sequence, or the sequence cyclic shift value may be 10 for a bit sequence of {1,0} for the zero-padded HARQ bit sequence.

In some aspects, the HARQ information includes one bit or two bits, and the payload size of the zero-padded HARQ bit sequence includes three bits, and the UE 115 may encode the UCI in accordance with a Reed-Muller code, and may multiplex the UCI message via an uplink shared channel. Additionally, or alternatively, the UE 115 may encode the UCI using the Reed-Muller code, and may transmit the UCI message in accordance with a PUCCH format 2, a PUCCH format 3, or a PUCCH format 4.

In some implementations, the UE 115 may receive, from the network entity 105, control signaling that indicates a transmission scheme for the UCI message. For example, the transmission scheme may be based on a zero-padding configuration, an uplink channel and UCI payload multiplexing configuration, an uplink control channel format indication, or any combination thereof. In some examples, the network entity 105 may transmit the control signaling via RRC signaling, MAC-CE signaling, one or more DCI messages, or any combination thereof.

At 525, the network entity 105 may decode the HARQ information of the UCI message in accordance with a sequence cyclic shift value corresponding to a payload size of the zero-padded HARQ bit sequence that includes two bits or three bits. In some cases, the zero-padded HARQ bit sequence includes the HARQ information received via the UCI message and one or more zero-padding bits implied by the network entity 105 (e.g., the network entity 105 may assume implicit zero-padding bits are added to the HARQ information included in the UCI message).

In some examples where the HARQ information includes one bit, the network entity 105 may decode the UCI in accordance with a first uplink control channel format (e.g., PF0) or a second uplink control channel format (e.g., PF1) that does not include a scheduling request, and the sequence cyclic shift value may be based on the zero-padded HARQ bit sequence including the one bit of the HARQ information and one zero-padding bit implied by the network entity 105. For example, for the first uplink control channel format (e.g., PF0) the sequence shift value may be 0 associated with a bit sequence of {0,0} for the zero-padded HARQ bit sequence, or the sequence shift value may be 6 associated with a bit sequence of {1,0} for the zero-padded HARQ bit sequence. Additionally, or alternatively, for the second uplink control channel format (e.g., PF1), the sequence cyclic shift may be associated with a QPSK mapping associated with a bit sequence of {0,0} for the zero-padded HARQ bit sequence, or a sequence cyclic shift associated with a QPSK mapping associated with a bit sequence of {1,0} for the zero-padded HARQ bit sequence.

In some examples where the HARQ information includes one bit, the network entity 105 may decode the UCI in accordance with a first uplink control channel format or a second uplink control channel format that includes either a positive scheduling request or a negative scheduling request, where the sequence cyclic shift value may be based on the zero-padded HARQ bit sequence including the one bit of the HARQ information and one zero padding bit implied by the network entity 105. In some examples, if the first uplink control channel format includes a negative scheduling request, the sequence cyclic shift value may be 0 associated with the bit sequence of {0,0} for the zero-padded HARQ bit sequence, or the sequence cyclic shift value may be 6 associated with a bit sequence of {1,0} for the zero-padded HARQ bit sequence. Additionally, or alternatively, for the first uplink control channel format that includes the positive scheduling request, the sequence cyclic shift value may be 3 associated with a bit sequence of {0,0}, or the sequence cyclic shift value may be 9 associated with a bit sequence of {1,0} for the zero-padded HARQ bit sequence.

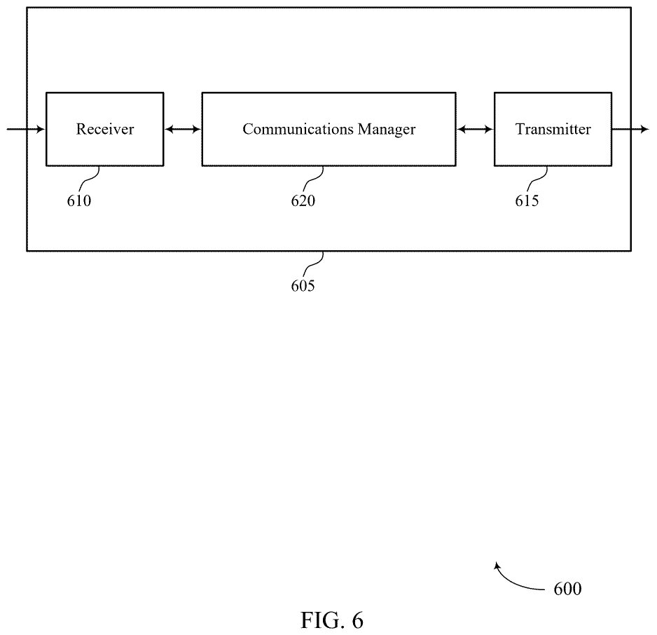

FIG. 6 shows a block diagram 600 of a device 605 that supports techniques for handling HARQ-ACK codebook size mismatch in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for handling HARQ-ACK codebook size mismatch). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for handling HARQ-ACK codebook size mismatch). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for handling HARQ-ACK codebook size mismatch as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, from a network entity, one or more downlink messages. The communications manager 620 is capable of, configured to, or operable to support a means for generating HARQ information corresponding to respective downlink messages of the one or more downlink messages, the HARQ information including one bit or two bits. The communications manager 620 is capable of, configured to, or operable to support a means for generating an uplink control information message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits. The communications manager 620 is capable of, configured to, or operable to support a means for transmitting the uplink control information message in accordance with a sequence cyclic shift value corresponding to the payload size of the zero-padded HARQ bit sequence.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, more efficient utilization of communication resources, reduced signaling overhead, and improved HARQ-ACK interpretation and encoding accuracy.

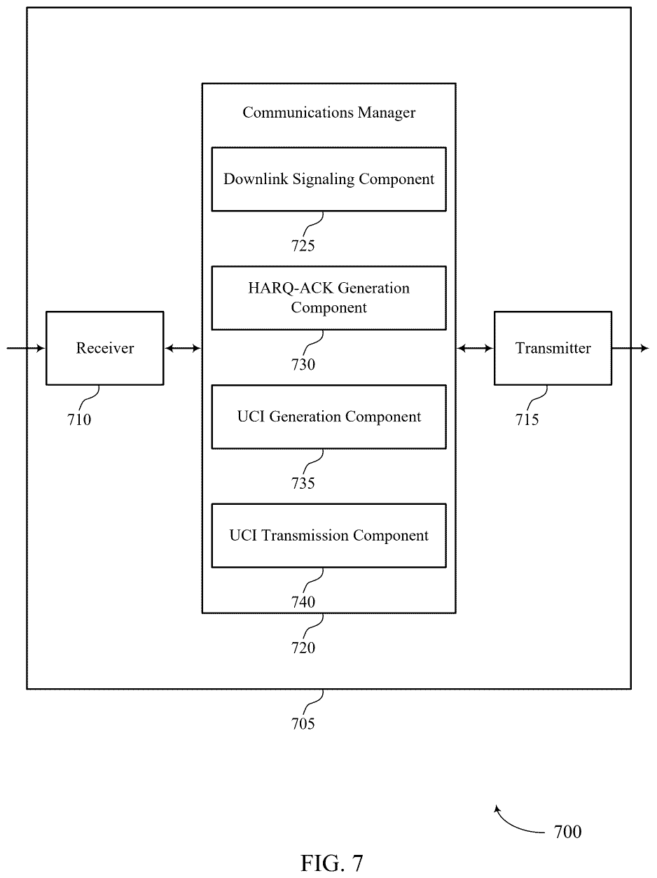

FIG. 7 shows a block diagram 700 of a device 705 that supports techniques for handling HARQ-ACK codebook size mismatch in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for handling HARQ-ACK codebook size mismatch). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for handling HARQ-ACK codebook size mismatch). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for handling HARQ-ACK codebook size mismatch as described herein. For example, the communications manager 720 may include a downlink signaling component 725, an HARQ-ACK generation component 730, a UCI generation component 735, a UCI transmission component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The downlink signaling component 725 is capable of, configured to, or operable to support a means for receiving, from a network entity, one or more downlink messages. The HARQ-ACK generation component 730 is capable of, configured to, or operable to support a means for generating HARQ information corresponding to respective downlink messages of the one or more downlink messages, the HARQ information including one bit or two bits. The UCI generation component 735 is capable of, configured to, or operable to support a means for generating an uplink control information message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits. The UCI transmission component 740 is capable of, configured to, or operable to support a means for transmitting the uplink control information message in accordance with a sequence cyclic shift value corresponding to the payload size of the zero-padded HARQ bit sequence.

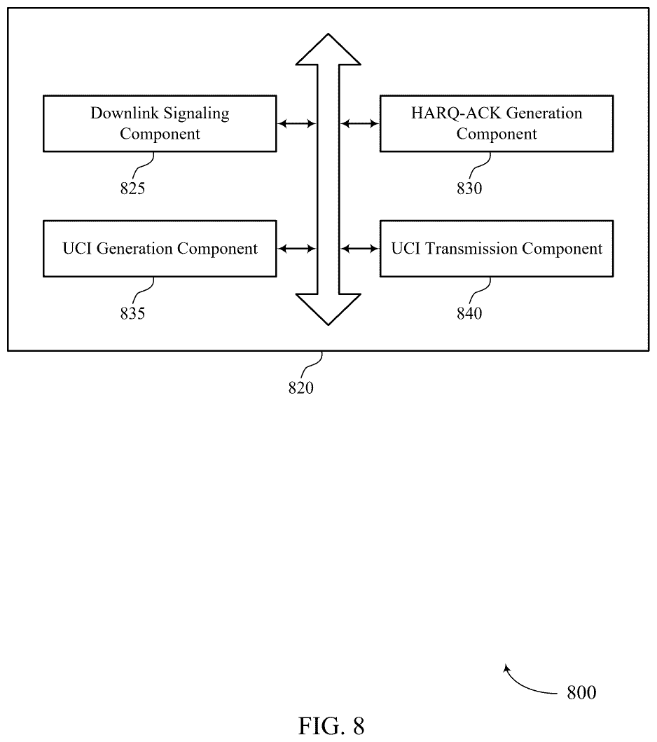

FIG. 8 shows a block diagram 800 of a communications manager 820 that supports techniques for handling HARQ-ACK codebook size mismatch in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for handling HARQ-ACK codebook size mismatch as described herein. For example, the communications manager 820 may include a downlink signaling component 825, an HARQ-ACK generation component 830, a UCI generation component 835, a UCI transmission component 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The downlink signaling component 825 is capable of, configured to, or operable to support a means for receiving, from a network entity, one or more downlink messages. The HARQ-ACK generation component 830 is capable of, configured to, or operable to support a means for generating HARQ information corresponding to respective downlink messages of the one or more downlink messages, the HARQ information including one bit or two bits. The UCI generation component 835 is capable of, configured to, or operable to support a means for generating an uplink control information message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits. The UCI transmission component 840 is capable of, configured to, or operable to support a means for transmitting the uplink control information message in accordance with a sequence cyclic shift value corresponding to the payload size of the zero-padded HARQ bit sequence.

In some examples, to support transmitting the uplink control information message, the UCI transmission component 840 is capable of, configured to, or operable to support a means for transmitting the uplink control information message in accordance with a first uplink control channel format or a second uplink control channel format that does not include a scheduling request, where the sequence cyclic shift value is based on the one bit of the HARQ information and one zero padding bit included in the zero-padded HARQ bit sequence. In some examples, for the first uplink control channel format, the sequence cyclic shift value includes a sequence cyclic shift value of 0 associated with a bit sequence of {0,0} for the zero-padded HARQ bit sequence, or a sequence cyclic shift value of 9 associated with a bit sequence of {1,0} for the zero-padded HARQ bit sequence.

In some examples, for the second uplink control channel format, the sequence cyclic shift value includes a sequence cyclic shift associated with a QPSK mapping associated with a bit sequence of {0,0} for the zero-padded HARQ bit sequence, or a sequence cyclic shift associated with a QPSK mapping associated with a bit sequence of {1,0} for the zero-padded HARQ bit sequence. In some examples, the first uplink control channel format includes a PUCCH format 0 and the second uplink control channel format includes a PUCCH format 1.

In some examples, to support transmitting the uplink control information message, the UCI transmission component 840 is capable of, configured to, or operable to support a means for transmitting the uplink control information message in accordance with a first uplink control channel format or a second uplink control channel format that includes either a positive scheduling request or a negative scheduling request, where the sequence cyclic shift value is based on the one bit of the HARQ information and one zero padding bit included in the zero-padded HARQ bit sequence.

In some examples, for the first uplink control channel format that includes the negative scheduling request, the sequence cyclic shift value includes a sequence cyclic shift value of 0 associated with a bit sequence of {0,0} for the zero-padded HARQ bit sequence, or a sequence cyclic shift value of 9 associated with a bit sequence of {1,0} for the zero-padded HARQ bit sequence. In some examples, for the first uplink control channel format that includes the positive scheduling request, the sequence cyclic shift value includes a sequence cyclic shift value of 1 associated with a bit sequence of {0,0} for the zero-padded HARQ bit sequence, or a sequence cyclic shift value of 10 associated with a bit sequence of {1,0} the zero-padded HARQ bit sequence. In some examples, the first uplink control channel format includes a PUCCH format 0 and the second uplink control channel format includes a PUCCH format 1.

In some examples, to support transmitting the uplink control information message, the UCI transmission component 840 is capable of, configured to, or operable to support a means for multiplexing the uplink control information message via an uplink shared channel, where the uplink control information message is encoded in accordance with a Reed-Muller code. In some examples, to support transmitting the uplink control information message, the UCI transmission component 840 is capable of, configured to, or operable to support a means for transmitting the uplink control information message in accordance with a PUCCH format 2, a PUCCH format 3, or a PUCCH format 4, where the uplink control information message is encoded in accordance with a Reed-Muller code.

In some examples, the downlink signaling component 825 is capable of, configured to, or operable to support a means for receiving, from the network entity, control signaling indicating a transmission scheme for the uplink control information message, where the transmission scheme is based on a zero-padding configuration, an uplink channel and UCI payload multiplexing configuration, an uplink control channel format indication, or any combination thereof.

In some examples, the control signaling includes radio resource control signaling, a medium access control-control element, a downlink control information message, or any combination thereof.

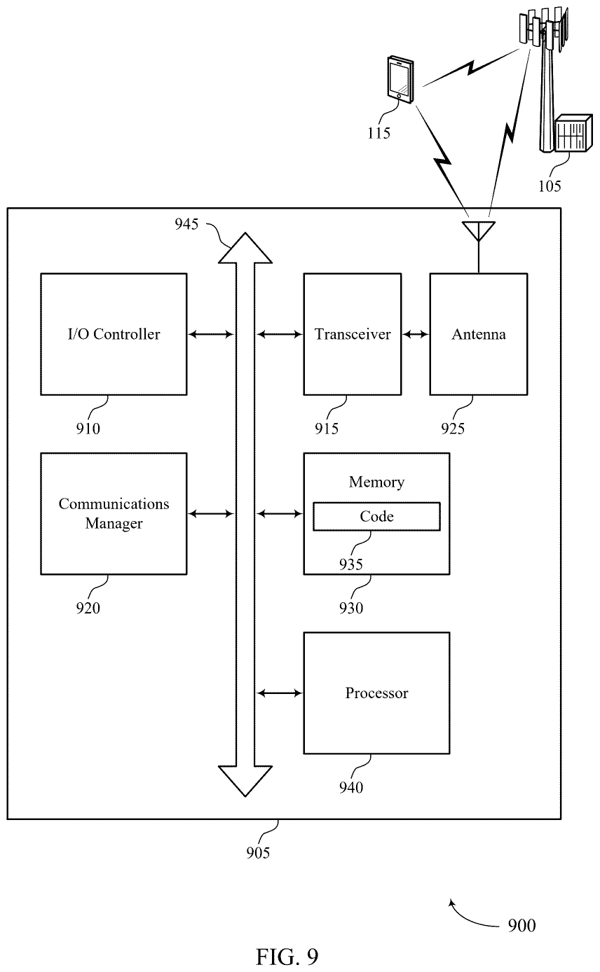

FIG. 9 shows a diagram of a system 900 including a device 905 that supports techniques for handling HARQ-ACK codebook size mismatch in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for handling HARQ-ACK codebook size mismatch). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving, from a network entity, one or more downlink messages. The communications manager 920 is capable of, configured to, or operable to support a means for generating HARQ information corresponding to respective downlink messages of the one or more downlink messages, the HARQ information including one bit or two bits. The communications manager 920 is capable of, configured to, or operable to support a means for generating an uplink control information message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits. The communications manager 920 is capable of, configured to, or operable to support a means for transmitting the uplink control information message in accordance with a sequence cyclic shift value corresponding to the payload size of the zero-padded HARQ bit sequence.

By including or configuring the communications manager 920 in accordance with examples as described herein, the device 905 may support techniques for improved communication reliability, reduced latency, reduced power consumption, more efficient utilization of communication resources, improved coordination between devices, longer battery life, improved utilization of processing capability, and improved HARQ-ACK interpretation and encoding accuracy.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for handling HARQ-ACK codebook size mismatch as described herein, or the at least one processor 940 and the at least one memory 930 may be otherwise configured to, individually or collectively, perform or support such operations.

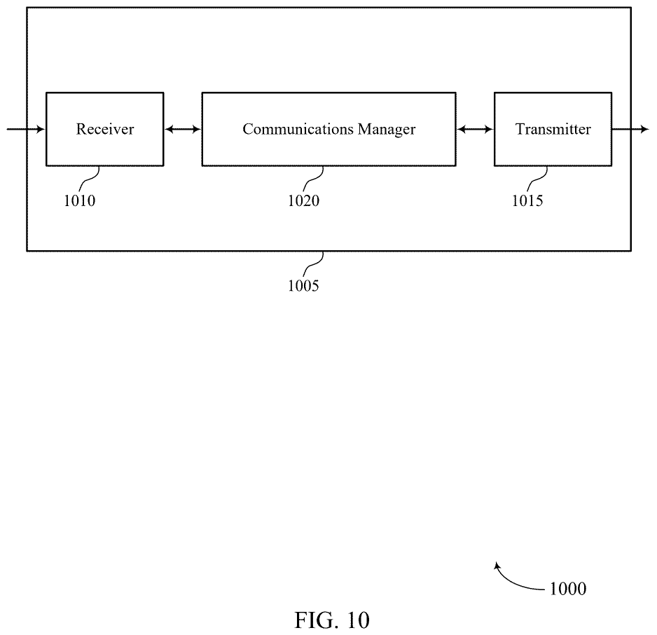

FIG. 10 shows a block diagram 1000 of a device 1005 that supports techniques for handling HARQ-ACK codebook size mismatch in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for handling HARQ-ACK codebook size mismatch as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, to a UE, one or more downlink messages. The communications manager 1020 is capable of, configured to, or operable to support a means for obtaining, from the UE, an uplink control information message including HARQ information corresponding to respective downlink messages of the one or more downlink messages, the HARQ information including one bit or two bits. The communications manager 1020 is capable of, configured to, or operable to support a means for decoding the HARQ information of the uplink control information message in accordance with a sequence cyclic shift value corresponding to a payload size of a zero-padded HARQ bit sequence including two bits or three bits, where the zero-padded HARQ bit sequence includes the HARQ information received via the uplink control information message and one or more zero-padding bits implied by the network entity.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, more efficient utilization of communication resources, reduced signaling overhead, and improved HARQ-ACK interpretation and encoding accuracy.

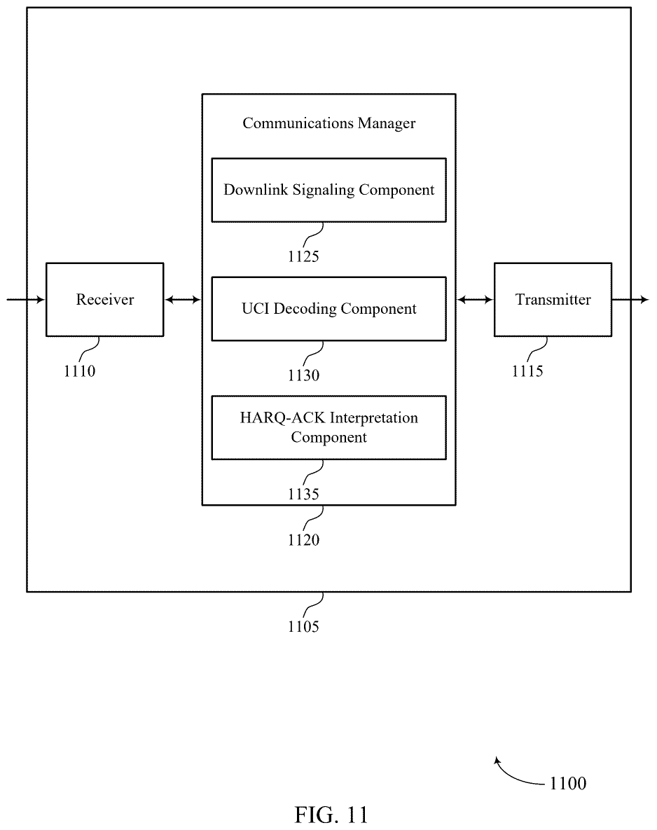

FIG. 11 shows a block diagram 1100 of a device 1105 that supports techniques for handling HARQ-ACK codebook size mismatch in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for handling HARQ-ACK codebook size mismatch as described herein. For example, the communications manager 1120 may include a downlink signaling component 1125, a UCI decoding component 1130, an HARQ-ACK interpretation component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The downlink signaling component 1125 is capable of, configured to, or operable to support a means for outputting, to a UE, one or more downlink messages. The UCI decoding component 1130 is capable of, configured to, or operable to support a means for obtaining, from the UE, an uplink control information message including HARQ information corresponding to respective downlink messages of the one or more downlink messages, the HARQ information including one bit or two bits. The HARQ-ACK interpretation component 1135 is capable of, configured to, or operable to support a means for decoding the HARQ information of the uplink control information message in accordance with a sequence cyclic shift value corresponding to a payload size of a zero-padded HARQ bit sequence including two bits or three bits, where the zero-padded HARQ bit sequence includes the HARQ information received via the uplink control information message and one or more zero-padding bits implied by the network entity.

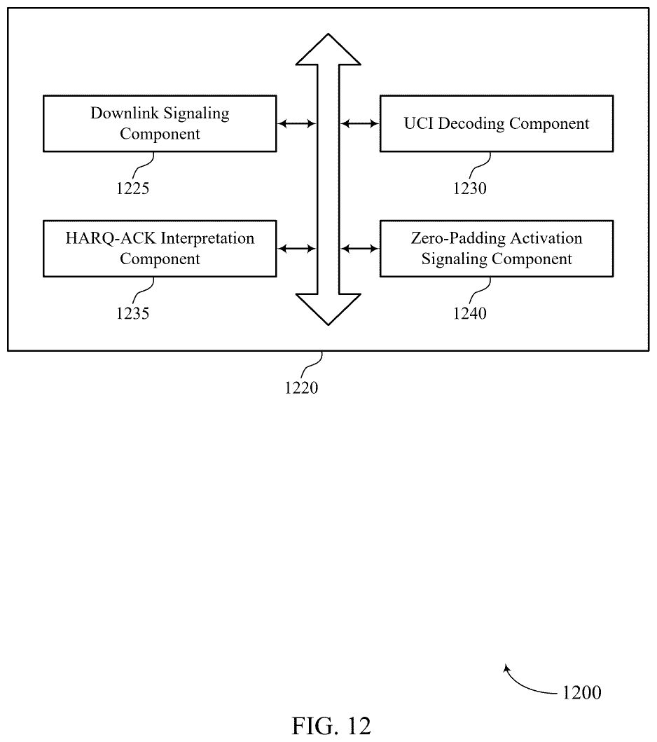

FIG. 12 shows a block diagram 1200 of a communications manager 1220 that supports techniques for handling HARQ-ACK codebook size mismatch in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for handling HARQ-ACK codebook size mismatch as described herein. For example, the communications manager 1220 may include a downlink signaling component 1225, a UCI decoding component 1230, an HARQ-ACK interpretation component 1235, a zero-padding activation signaling component 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The downlink signaling component 1225 is capable of, configured to, or operable to support a means for outputting, to a UE, one or more downlink messages. The UCI decoding component 1230 is capable of, configured to, or operable to support a means for obtaining, from the UE, an uplink control information message including HARQ information corresponding to respective downlink messages of the one or more downlink messages, the HARQ information including one bit or two bits. The HARQ-ACK interpretation component 1235 is capable of, configured to, or operable to support a means for decoding the HARQ information of the uplink control information message in accordance with a sequence cyclic shift value corresponding to a payload size of a zero-padded HARQ bit sequence including two bits or three bits, where the zero-padded HARQ bit sequence includes the HARQ information received via the uplink control information message and one or more zero-padding bits implied by the network entity.

In some examples, to support decoding the uplink control information message, the UCI decoding component 1230 is capable of, configured to, or operable to support a means for decoding the uplink control information message in accordance with a first uplink control channel format or a second uplink control channel format that does not include a scheduling request, where the sequence cyclic shift value is based on the zero-padded HARQ bit sequence including the one bit of the HARQ information and one zero-padding bit implied by the network entity. In some examples, for the first uplink control channel format, the sequence cyclic shift value includes a sequence cyclic shift value of 0 associated with a bit sequence of {0,0} for the zero-padded HARQ bit sequence, or a sequence cyclic shift value of 6 associated with a bit sequence of {1,0} for the zero-padded HARQ bit sequence.

In some examples, for the second uplink control channel format, the sequence cyclic shift value includes a sequence cyclic shift associated with a QPSK mapping associated with a bit sequence of {0,0} for the zero-padded HARQ bit sequence, or a sequence cyclic shift associated with a QPSK mapping associated with a bit sequence of {1,0} for the zero-padded HARQ bit sequence. In some examples, the first uplink control channel format includes a PUCCH format 0 and the second uplink control channel format includes a PUCCH format 1.

In some examples, to support decoding the uplink control information message, the UCI decoding component 1230 is capable of, configured to, or operable to support a means for decoding the uplink control information message in accordance with a first uplink control channel format or a second uplink control channel format that includes either a positive scheduling request or a negative scheduling request, where the sequence cyclic shift value is based on the zero-padded HARQ bit sequence including the one bit of the HARQ information and one zero padding bit implied by the network entity.

In some examples, for the first uplink control channel format that includes the negative scheduling request, the sequence cyclic shift value includes a sequence cyclic shift value of 0 associated with a bit sequence of {0,0} for the zero-padded HARQ bit sequence, or a sequence cyclic shift value of 6 associated with a bit sequence of {1,0} for the zero-padded HARQ bit sequence. In some examples, for the first uplink control channel format that includes the positive scheduling request, the sequence cyclic shift value includes a sequence cyclic shift value of 3 associated with a bit sequence of {0,0} for the zero-padded HARQ bit sequence, or a sequence cyclic shift value of 9 associated with a bit sequence of {1,0} for the zero-padded HARQ bit sequence. In some examples, the first uplink control channel format includes a PUCCH format 0 and the second uplink control channel format includes a PUCCH format 1.

In some examples, the zero-padding activation signaling component 1240 is capable of, configured to, or operable to support a means for outputting one or more messages that indicate an enablement or a disablement of a transmission scheme associated with the one or more zero-padding bits being implied by the network entity.

In some examples, the zero-padding activation signaling component 1240 is capable of, configured to, or operable to support a means for outputting, to the UE, control signaling indicative of an activation or deactivation of a transmission scheme for the uplink control information message, where the transmission scheme is based on a zero-padding configuration, an uplink channel and UCI payload multiplexing configuration, an uplink control channel format indication, or any combination thereof.

In some examples, the control signaling includes radio resource control signaling, a medium access control-control element, a downlink control information message, or any combination thereof.

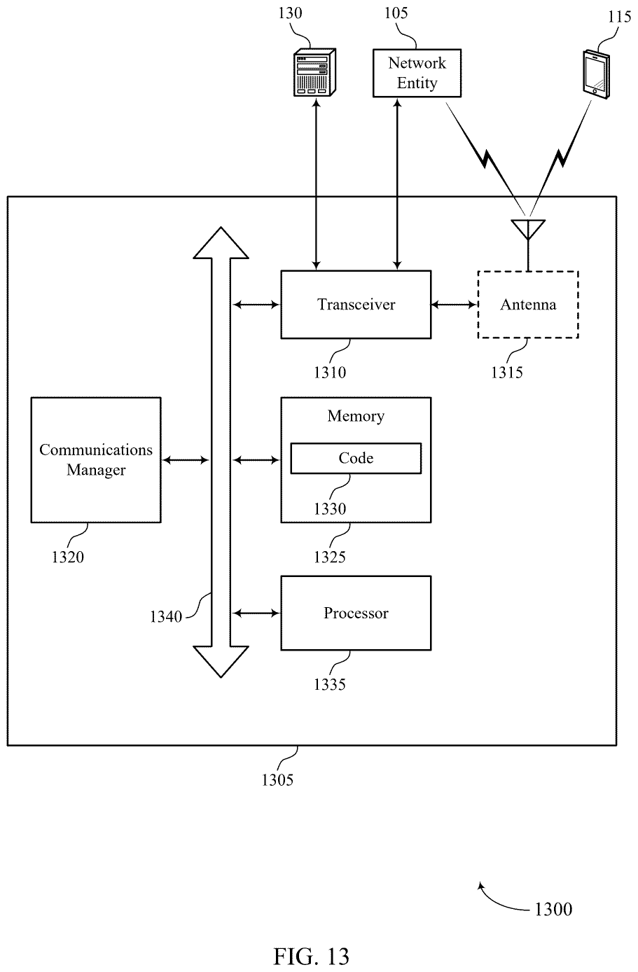

FIG. 13 shows a diagram of a system 1300 including a device 1305 that supports techniques for handling HARQ-ACK codebook size mismatch in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for handling HARQ-ACK codebook size mismatch). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, to a UE, one or more downlink messages. The communications manager 1320 is capable of, configured to, or operable to support a means for obtaining, from the UE, an uplink control information message including HARQ information corresponding to respective downlink messages of the one or more downlink messages, the HARQ information including one bit or two bits. The communications manager 1320 is capable of, configured to, or operable to support a means for decoding the HARQ information of the uplink control information message in accordance with a sequence cyclic shift value corresponding to a payload size of a zero-padded HARQ bit sequence including two bits or three bits, where the zero-padded HARQ bit sequence includes the HARQ information received via the uplink control information message and one or more zero-padding bits implied by the network entity.

By including or configuring the communications manager 1320 in accordance with examples as described herein, the device 1305 may support techniques for improved communication reliability, reduced latency, reduced power consumption, more efficient utilization of communication resources, improved coordination between devices, longer battery life, improved utilization of processing capability, and improved HARQ-ACK interpretation and encoding accuracy.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for handling HARQ-ACK codebook size mismatch as described herein, or the at least one processor 1335 and the at least one memory 1325 may be otherwise configured to, individually or collectively, perform or support such operations.

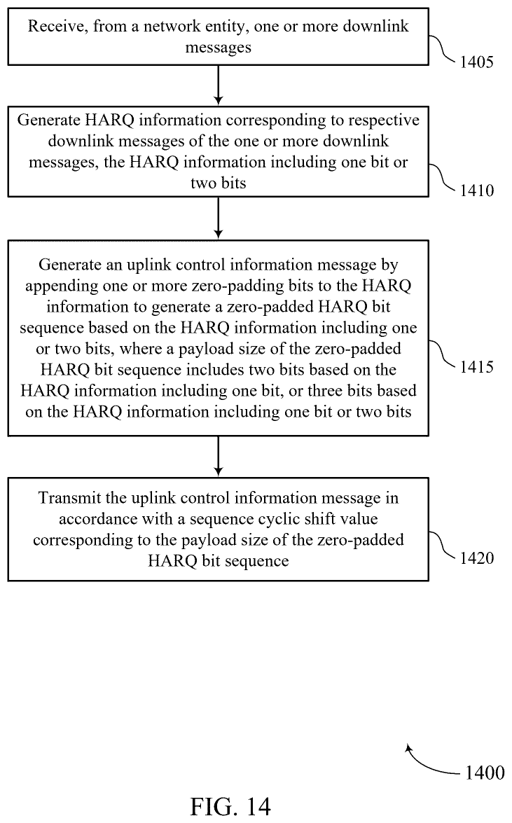

FIG. 14 shows a flowchart illustrating a method 1400 that supports techniques for handling HARQ-ACK codebook size mismatch in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, one or more downlink messages. The operations of 1405 may be performed in accordance with examples as disclosed herein. In some examples, aspects of the operations of 1405 may be performed by a downlink signaling component 825 as described with reference to FIG. 8. In some examples, aspects of 1405 may be performed at or by a UE 115 or a device 905 described herein.

At 1410, the method may include generating HARQ information corresponding to respective downlink messages of the one or more downlink messages, the HARQ information including one bit or two bits. The operations of 1410 may be performed in accordance with examples as disclosed herein. In some examples, aspects of the operations of 1410 may be performed by an HARQ-ACK generation component 830 as described with reference to FIG. 8. In some examples, aspects of 1410 may be performed at or by a UE 115 or a device 905 described herein.

At 1415, the method may include generating an uplink control information message by appending one or more zero-padding bits to the HARQ information to generate a zero-padded HARQ bit sequence based on the HARQ information including one or two bits, where a payload size of the zero-padded HARQ bit sequence includes two bits based on the HARQ information including one bit, or three bits based on the HARQ information including one bit or two bits. The operations of 1415 may be performed in accordance with examples as disclosed herein. In some examples, aspects of the operations of 1415 may be performed by a UCI generation component 835 as described with reference to FIG. 8. In some examples, aspects of 1415 may be performed at or by a UE 115 or a device 905 described herein.

At 1420, the method may include transmitting the uplink control information message in accordance with a sequence cyclic shift value corresponding to the payload size of the zero-padded HARQ bit sequence. The operations of 1420 may be performed in accordance with examples as disclosed herein. In some examples, aspects of the operations of 1420 may be performed by a UCI transmission component 840 as described with reference to FIG. 8. In some examples, aspects of 1420 may be performed at or by a UE 115 or a device 905 described herein.

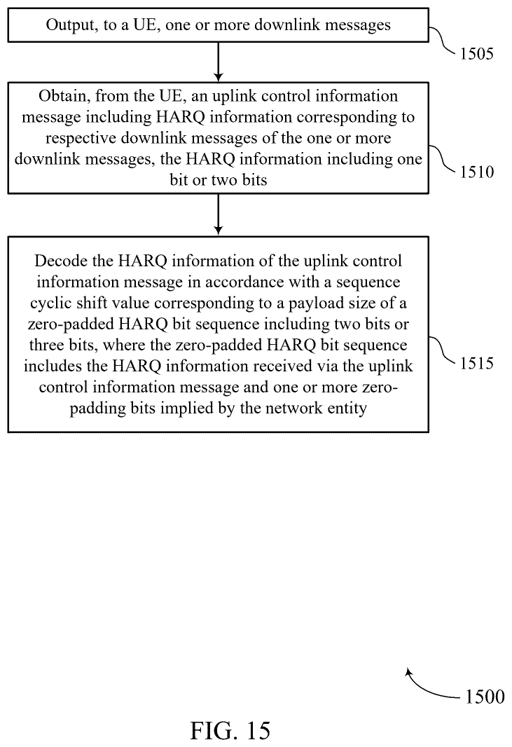

FIG. 15 shows a flowchart illustrating a method 1500 that supports techniques for handling HARQ-ACK codebook size mismatch in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, one or more downlink messages. The operations of 1505 may be performed in accordance with examples as disclosed herein. In some examples, aspects of the operations of 1505 may be performed by a downlink signaling component 1225 as described with reference to FIG. 12. In some examples, aspects of 1505 may be performed at or by a network entity 105 or a device 1305 described herein.

At 1510, the method may include obtaining, from the UE, an uplink control information message including HARQ information corresponding to respective downlink messages of the one or more downlink messages, the HARQ information including one bit or two bits. The operations of 1510 may be performed in accordance with examples as disclosed herein. In some examples, aspects of the operations of 1510 may be performed by a UCI decoding component 1230 as described with reference to FIG. 12. In some examples, aspects of 1510 may be performed at or by a network entity 105 or a device 1305 described herein.

At 1515, the method may include decoding the HARQ information of the uplink control information message in accordance with a sequence cyclic shift value corresponding to a payload size of a zero-padded HARQ bit sequence including two bits or three bits, where the zero-padded HARQ bit sequence includes the HARQ information received via the uplink control information message and one or more zero-padding bits implied by the network entity. The operations of 1515 may be performed in accordance with examples as disclosed herein. In some examples, aspects of the operations of 1515 may be performed by an HARQ-ACK interpretation component 1235 as described with reference to FIG. 12. In some examples, aspects of 1515 may be performed at or by a network entity 105 or a device 1305 described herein.

The following provides an overview of aspects of the present disclosure:

Aspect 1: A method for wireless communications at a UE, comprising: receiving, from a network entity, one or more downlink messages; generating HARQ information corresponding to respective downlink messages of the one or more downlink messages, the HARQ information comprising one bit or two bits; generating an UCI message by appending one or more zero-padding bits to the HARQ information to generate a zero-padded HARQ bit sequence based at least in part on the HARQ information comprising one or two bits, wherein a payload size of the zero-padded HARQ bit sequence comprises two bits based at least in part on the HARQ information comprising one bit, or three bits based at least in part on the HARQ information comprising one bit or two bits; and transmitting the UCI message in accordance with a sequence cyclic shift value corresponding to the payload size of the zero-padded HARQ bit sequence.

Aspect 2: The method of aspect 1, wherein the HARQ information comprises one bit and the payload size of the zero-padded HARQ bit sequence comprises two bits, wherein transmitting the UCI message comprises: transmitting the UCI message in accordance with a first uplink control channel format or a second uplink control channel format that does not include a scheduling request, wherein the sequence cyclic shift value is based at least in part on the one bit of the HARQ information and one zero padding bit included in the zero-padded HARQ bit sequence.

Aspect 3: The method of aspect 2, wherein for the first uplink control channel format, the sequence cyclic shift value comprises a sequence cyclic shift value of 0 associated with a bit sequence of {0,0} for the zero-padded HARQ bit sequence, or a sequence cyclic shift value of 9 associated with a bit sequence of {1,0} for the zero-padded HARQ bit sequence.

Aspect 4: The method of any of aspects 2 through 3, wherein for the second uplink control channel format, the sequence cyclic shift value comprises a sequence cyclic shift associated with a QPSK mapping associated with a bit sequence of {0,0} for the zero-padded HARQ bit sequence, or a sequence cyclic shift associated with a QPSK mapping associated with a bit sequence of {1,0} for the zero-padded HARQ bit sequence.

Aspect 5: The method of any of aspects 2 through 4, wherein the first uplink control channel format comprises a PUCCH format 0 and the second uplink control channel format comprises a PUCCH format 1.

Aspect 6: The method of any of aspects 1 through 5, wherein the HARQ information comprises one bit and the payload size of the zero-padded HARQ bit sequence comprises two bits, wherein transmitting the UCI message comprises: transmitting the UCI message in accordance with a first uplink control channel format or a second uplink control channel format that includes either a positive scheduling request or a negative scheduling request, wherein the sequence cyclic shift value is based at least in part on the one bit of the HARQ information and one zero padding bit included in the zero-padded HARQ bit sequence.

Aspect 7: The method of aspect 6, wherein for the first uplink control channel format that includes the negative scheduling request, the sequence cyclic shift value comprises a sequence cyclic shift value of 0 associated with a bit sequence of {0,0} for the zero-padded HARQ bit sequence, or a sequence cyclic shift value of 9 associated with a bit sequence of {1,0} for the zero-padded HARQ bit sequence.

Aspect 8: The method of any of aspects 6 through 7, wherein for the first uplink control channel format that includes the positive scheduling request, the sequence cyclic shift value comprises a sequence cyclic shift value of 1 associated with a bit sequence of {0,0} for the zero-padded HARQ bit sequence, or a sequence cyclic shift value of 10 associated with a bit sequence of {1,0} the zero-padded HARQ bit sequence.

Aspect 9: The method of any of aspects 6 through 8, wherein the first uplink control channel format comprises a PUCCH format 0 and the second uplink control channel format comprises a PUCCH format 1.

Aspect 10: The method of any of aspects 1 through 9, wherein the HARQ information comprises one bit or two bits and the payload size of the zero-padded HARQ bit sequence comprises three bits, wherein transmitting the UCI message comprises: multiplexing the UCI message via an uplink shared channel, wherein the UCI message is encoded in accordance with a Reed-Muller code.

Aspect 11: The method of any of aspects 1 through 10, wherein the HARQ information comprises one bit or two bits and the payload size of the zero-padded HARQ bit sequence comprises three bits, wherein transmitting the UCI message comprises: transmitting the UCI message in accordance with a PUCCH format 2, a PUCCH format 3, or a PUCCH format 4, wherein the UCI message is encoded in accordance with a Reed-Muller code.

Aspect 12: The method of any of aspects 1 through 11, further comprising: receiving, from the network entity, control signaling indicating a transmission scheme for the UCI message, wherein the transmission scheme is based at least in part on a zero-padding configuration, an uplink channel and UCI payload multiplexing configuration, an uplink control channel format indication, or any combination thereof.

Aspect 13: The method of aspect 12, wherein the control signaling comprises radio resource control signaling, a medium access control-control element, a downlink control information message, or any combination thereof.

Aspect 14: A method for wireless communications at a network entity, comprising: outputting, to a UE, one or more downlink messages; obtaining, from the UE, an UCI message comprising HARQ information corresponding to respective downlink messages of the one or more downlink messages, the HARQ information comprising one bit or two bits; and decoding the HARQ information of the UCI message in accordance with a sequence cyclic shift value corresponding to a payload size of a zero-padded HARQ bit sequence comprising two bits or three bits, wherein the zero-padded HARQ bit sequence comprises the HARQ information received via the UCI message and one or more zero-padding bits implied by the network entity.

Aspect 15: The method of aspect 14, wherein the HARQ information comprises one bit, wherein decoding the UCI message comprises: decoding the UCI message in accordance with a first uplink control channel format or a second uplink control channel format that does not include a scheduling request, wherein the sequence cyclic shift value is based at least in part on the zero-padded HARQ bit sequence comprising the one bit of the HARQ information and one zero-padding bit implied by the network entity.

Aspect 16: The method of aspect 15, wherein for the first uplink control channel format, the sequence cyclic shift value comprises a sequence cyclic shift value of 0 associated with a bit sequence of {0,0} for the zero-padded HARQ bit sequence, or a sequence cyclic shift value of 6 associated with a bit sequence of {1,0} for the zero-padded HARQ bit sequence.

Aspect 17: The method of any of aspects 15 through 16, wherein for the second uplink control channel format, the sequence cyclic shift value comprises a sequence cyclic shift associated with a QPSK mapping associated with a bit sequence of {0,0} for the zero-padded HARQ bit sequence, or a sequence cyclic shift associated with a QPSK mapping associated with a bit sequence of {1,0} for the zero-padded HARQ bit sequence.

Aspect 18: The method of any of aspects 15 through 17, wherein the first uplink control channel format comprises a PUCCH format 0 and the second uplink control channel format comprises a PUCCH format 1.

Aspect 19: The method of any of aspects 14 through 18, wherein the HARQ information comprises one bit, wherein decoding the UCI message comprises: decoding the UCI message in accordance with a first uplink control channel format or a second uplink control channel format that includes either a positive scheduling request or a negative scheduling request, wherein the sequence cyclic shift value is based at least in part on the zero-padded HARQ bit sequence comprising the one bit of the HARQ information and one zero padding bit implied by the network entity.

Aspect 20: The method of aspect 19, wherein for the first uplink control channel format that includes the negative scheduling request, the sequence cyclic shift value comprises a sequence cyclic shift value of 0 associated with a bit sequence of {0,0} for the zero-padded HARQ bit sequence, or a sequence cyclic shift value of 6 associated with a bit sequence of {1,0} for the zero-padded HARQ bit sequence.

Aspect 21: The method of any of aspects 19 through 20, wherein for the first uplink control channel format that includes the positive scheduling request, the sequence cyclic shift value comprises a sequence cyclic shift value of 3 associated with a bit sequence of {0,0} for the zero-padded HARQ bit sequence, or a sequence cyclic shift value of 9 associated with a bit sequence of {1,0} for the zero-padded HARQ bit sequence.

Aspect 22: The method of any of aspects 19 through 21, wherein the first uplink control channel format comprises a PUCCH format 0 and the second uplink control channel format comprises a PUCCH format 1.

Aspect 23: The method of any of aspects 14 through 22, further comprising: outputting one or more messages that indicate an enablement or a disablement of a transmission scheme associated with the one or more zero-padding bits being implied by the network entity.

Aspect 24: The method of any of aspects 14 through 23, further comprising: outputting, to the UE, control signaling indicative of an activation or deactivation of a transmission scheme for the UCI message, wherein the transmission scheme is based at least in part on a zero-padding configuration, an uplink channel and UCI payload multiplexing configuration, an uplink control channel format indication, or any combination thereof.

Aspect 25: The method of aspect 24, wherein the control signaling comprises radio resource control signaling, a MAC-CE, a DCI, or any combination thereof.

Aspect 26: A UE for wireless communications, comprising one or more memories storing processor-executable code, and one or more processors coupled with the one or more memories and individually or collectively operable to execute the code to cause the UE to perform a method of any of aspects 1 through 13.

Aspect 27: A UE for wireless communications, comprising at least one means for performing a method of any of aspects 1 through 13.

Aspect 28: A non-transitory computer-readable medium storing code for wireless communications, the code comprising instructions executable by one or more processors to perform a method of any of aspects 1 through 13.

Aspect 29: A network entity for wireless communications, comprising one or more memories storing processor-executable code, and one or more processors coupled with the one or more memories and individually or collectively operable to execute the code to cause the network entity to perform a method of any of aspects 14 through 25.

Aspect 30: A network entity for wireless communications, comprising at least one means for performing a method of any of aspects 14 through 25.

Aspect 31: A non-transitory computer-readable medium storing code for wireless communications, the code comprising instructions executable by one or more processors to perform a method of any of aspects 14 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, one or more downlink messages;
generate hybrid automatic repeat request (HARQ) information corresponding to respective downlink messages of the one or more downlink messages, the HARQ information comprising one bit or two bits;
generate an uplink control information message by appending one or more zero-padding bits to the HARQ information to generate a zero-padded HARQ bit sequence based at least in part on the HARQ information comprising one or two bits, wherein a payload size of the zero-padded HARQ bit sequence comprises two bits based at least in part on the HARQ information comprising one bit, or three bits based at least in part on the HARQ information comprising one bit or two bits; and
transmit the uplink control information message in accordance with a sequence cyclic shift value corresponding to the payload size of the zero-padded HARQ bit sequence.

2. The UE of claim 1, wherein the HARQ information comprises one bit and the payload size of the zero-padded HARQ bit sequence comprises two bits, and wherein, to transmit the uplink control information message, the one or more processors are individually or collectively operable to execute the code to cause the UE to:
transmit the uplink control information message in accordance with a first uplink control channel format or a second uplink control channel format that does not include a scheduling request, wherein the sequence cyclic shift value is based at least in part on the one bit of the HARQ information and one zero padding bit included in the zero-padded HARQ bit sequence.

3. The UE of claim 2, wherein, for the first uplink control channel format, the sequence cyclic shift value comprises:
a sequence cyclic shift value of 0 associated with a bit sequence of {0,0} for the zero-padded HARQ bit sequence; or
a sequence cyclic shift value of 9 associated with a bit sequence of {1,0} for the zero-padded HARQ bit sequence.

4. The UE of claim 2, wherein, for the second uplink control channel format, the sequence cyclic shift value comprises:
a sequence cyclic shift associated with a quadrature phase shift keying (QPSK) mapping associated with a bit sequence of {0,0} for the zero-padded HARQ bit sequence; or
a sequence cyclic shift associated with a QPSK mapping associated with a bit sequence of {1,0} for the zero-padded HARQ bit sequence.

5. The UE of claim 2, wherein the first uplink control channel format comprises a physical uplink control channel (PUCCH) format 0 and the second uplink control channel format comprises a PUCCH format 1.

6. The UE of claim 1, wherein the HARQ information comprises one bit and the payload size of the zero-padded HARQ bit sequence comprises two bits, and wherein, to transmit the uplink control information message, the one or more processors are individually or collectively operable to execute the code to cause the UE to:
transmit the uplink control information message in accordance with a first uplink control channel format or a second uplink control channel format that includes either a positive scheduling request or a negative scheduling request, wherein the sequence cyclic shift value is based at least in part on the one bit of the HARQ information and one zero padding bit included in the zero-padded HARQ bit sequence.

7. The UE of claim 6, wherein for the first uplink control channel format that includes the negative scheduling request, the sequence cyclic shift value comprises:
a sequence cyclic shift value of 0 associated with a bit sequence of {0,0} for the zero-padded HARQ bit sequence; or
a sequence cyclic shift value of 9 associated with a bit sequence of {1,0} for the zero-padded HARQ bit sequence.

8. The UE of claim 6, wherein for the first uplink control channel format that includes the positive scheduling request, the sequence cyclic shift value comprises:
a sequence cyclic shift value of 1 associated with a bit sequence of {0,0} for the zero-padded HARQ bit sequence; or
a sequence cyclic shift value of 10 associated with a bit sequence of {1,0} the zero-padded HARQ bit sequence.

9. The UE of claim 6, wherein the first uplink control channel format comprises a physical uplink control channel (PUCCH) format 0 and the second uplink control channel format comprises a PUCCH format 1.

10. The UE of claim 1, wherein the HARQ information comprises one bit or two bits and the payload size of the zero-padded HARQ bit sequence comprises three bits, and wherein, to transmit the uplink control information message, the one or more processors are individually or collectively operable to execute the code to cause the UE to:
multiplex the uplink control information message via an uplink shared channel, wherein the uplink control information message is encoded in accordance with a Reed-Muller code.

11. The UE of claim 1, wherein the HARQ information comprises one bit or two bits and the payload size of the zero-padded HARQ bit sequence comprises three bits, and wherein, to transmit the uplink control information message, the one or more processors are individually or collectively operable to execute the code to cause the UE to:
transmit the uplink control information message in accordance with a physical uplink control channel (PUCCH) format 2, a PUCCH format 3, or a PUCCH format 4, wherein the uplink control information message is encoded in accordance with a Reed-Muller code.

12. The UE of claim 1, wherein the one or more processors are individually or collectively further operable to execute the code to cause the UE to:
receive, from the network entity, control signaling indicating a transmission scheme for the uplink control information message, wherein the transmission scheme is based at least in part on a zero-padding configuration, an uplink channel and UCI payload multiplexing configuration, an uplink control channel format indication, or any combination thereof.

13. The UE of claim 12, wherein the control signaling comprises radio resource control signaling, a medium access control-control element, a downlink control information message, or any combination thereof.

14. A network entity, comprising:
one or more memories storing processor-executable code; and
one or more processors coupled with the one or more memories and individually or collectively operable to execute the code to cause the network entity to:
output, to a user equipment (UE), one or more downlink messages;
obtain, from the UE, an uplink control information message comprising hybrid automatic repeat request (HARQ) information corresponding to respective downlink messages of the one or more downlink messages, the HARQ information comprising one bit or two bits; and
decode the HARQ information of the uplink control information message in accordance with a sequence cyclic shift value corresponding to a payload size of a zero-padded HARQ bit sequence comprising two bits or three bits, wherein the zero-padded HARQ bit sequence comprises the HARQ information received via the uplink control information message and one or more zero-padding bits implied by the network entity.

15. The network entity of claim 14, wherein the HARQ information comprises one bit, and wherein, to decode the uplink control information message, the one or more processors are individually or collectively operable to execute the code to cause the network entity to:
decode the uplink control information message in accordance with a first uplink control channel format or a second uplink control channel format that does not include a scheduling request, wherein the sequence cyclic shift value is based at least in part on the zero-padded HARQ bit sequence comprising the one bit of the HARQ information and one zero-padding bit implied by the network entity.

16. The network entity of claim 15, wherein for the first uplink control channel format, the sequence cyclic shift value comprises:
a sequence cyclic shift value of 0 associated with a bit sequence of {0,0} for the zero-padded HARQ bit sequence; or
a sequence cyclic shift value of 6 associated with a bit sequence of {1,0} for the zero-padded HARQ bit sequence.

17. The network entity of claim 15, wherein for the second uplink control channel format, the sequence cyclic shift value comprises:
a sequence cyclic shift associated with a quadrature phase shift keying (QPSK) mapping associated with a bit sequence of {0,0} for the zero-padded HARQ bit sequence; or
a sequence cyclic shift associated with a QPSK mapping associated with a bit sequence of {1,0} for the zero-padded HARQ bit sequence.

18. The network entity of claim 15, wherein the first uplink control channel format comprises a physical uplink control channel (PUCCH) format 0 and the second uplink control channel format comprises a PUCCH format 1.

19. The network entity of claim 14, wherein the HARQ information comprises one bit, and wherein, to decode the uplink control information message, the one or more processors are individually or collectively operable to execute the code to cause the network entity to:
decode the uplink control information message in accordance with a first uplink control channel format or a second uplink control channel format that includes either a positive scheduling request or a negative scheduling request, wherein the sequence cyclic shift value is based at least in part on the zero-padded HARQ bit sequence comprising the one bit of the HARQ information and one zero padding bit implied by the network entity.

20. The network entity of claim 19, wherein for the first uplink control channel format that includes the negative scheduling request, the sequence cyclic shift value comprises:
a sequence cyclic shift value of 0 associated with a bit sequence of {0,0} for the zero-padded HARQ bit sequence; or
a sequence cyclic shift value of 6 associated with a bit sequence of {1,0} for the zero-padded HARQ bit sequence.

21. The network entity of claim 19, wherein for the first uplink control channel format that includes the positive scheduling request, the sequence cyclic shift value comprises:
a sequence cyclic shift value of 3 associated with a bit sequence of {0,0} for the zero-padded HARQ bit sequence; or
a sequence cyclic shift value of 9 associated with a bit sequence of {1,0} for the zero-padded HARQ bit sequence.

22. The network entity of claim 19, wherein the first uplink control channel format comprises a physical uplink control channel (PUCCH) format 0 and the second uplink control channel format comprises a PUCCH format 1.

23. The network entity of claim 14, wherein the one or more processors are individually or collectively further operable to execute the code to cause the network entity to:
output one or more messages that indicate an enablement or a disablement of a transmission scheme associated with the one or more zero-padding bits being implied by the network entity.

24. The network entity of claim 14, wherein the one or more processors are individually or collectively further operable to execute the code to cause the network entity to:
output, to the UE, control signaling indicative of an activation or deactivation of a transmission scheme for the uplink control information message, wherein the transmission scheme is based at least in part on a zero-padding configuration, an uplink channel and UCI payload multiplexing configuration, an uplink control channel format indication, or any combination thereof.

25. The network entity of claim 24, wherein the control signaling comprises radio resource control signaling, a medium access control-control element, a downlink control information message, or any combination thereof.

26. A method for wireless communications at a user equipment (UE), comprising:
receiving, from a network entity, one or more downlink messages;
generating hybrid automatic repeat request (HARQ) information corresponding to respective downlink messages of the one or more downlink messages, the HARQ information comprising one bit or two bits;
generating an uplink control information message by appending one or more zero-padding bits to the HARQ information to generate a zero-padded HARQ bit sequence based at least in part on the HARQ information comprising one or two bits, wherein a payload size of the zero-padded HARQ bit sequence comprises two bits based at least in part on the HARQ information comprising one bit, or three bits based at least in part on the HARQ information comprising one bit or two bits; and
transmitting the uplink control information message in accordance with a sequence cyclic shift value corresponding to the payload size of the zero-padded HARQ bit sequence.

27. The method of claim 26, wherein the HARQ information comprises one bit and the payload size of the zero-padded HARQ bit sequence comprises two bits, wherein transmitting the uplink control information message comprises:
transmitting the uplink control information message in accordance with a first uplink control channel format or a second uplink control channel format that does not include a scheduling request, wherein the sequence cyclic shift value is based at least in part on the one bit of the HARQ information and one zero padding bit included in the zero-padded HARQ bit sequence.

28. The method of claim 27, wherein for the first uplink control channel format, the sequence cyclic shift value comprises:
a sequence cyclic shift value of 0 associated with a bit sequence of {0,0} for the zero-padded HARQ bit sequence; or
a sequence cyclic shift value of 9 associated with a bit sequence of {1,0} for the zero-padded HARQ bit sequence.

29. The method of claim 27, wherein for the second uplink control channel format, the sequence cyclic shift value comprises:
a sequence cyclic shift associated with a quadrature phase shift keying (QPSK) mapping associated with a bit sequence of {0,0} for the zero-padded HARQ bit sequence; or
a sequence cyclic shift associated with a QPSK mapping associated with a bit sequence of {1,0} for the zero-padded HARQ bit sequence.

30. A method for wireless communications at a network entity, comprising:
outputting, to a user equipment (UE), one or more downlink messages;
obtaining, from the UE, an uplink control information message comprising hybrid automatic repeat request (HARQ) information corresponding to respective downlink messages of the one or more downlink messages, the HARQ information comprising one bit or two bits; and
decoding the HARQ information of the uplink control information message in accordance with a sequence cyclic shift value corresponding to a payload size of a zero-padded HARQ bit sequence comprising two bits or three bits, wherein the zero-padded HARQ bit sequence comprises the HARQ information received via the uplink control information message and one or more zero-padding bits implied by the network entity.
